(19) United States
(12) Patent Application Publication
(10) Pub. No.: US 2024/0014372 A1
(43) Pub. Date: Jan. 11, 2024

(54) METHOD FOR MANUFACTURING ELECTRODE STRUCTURE FOR POSITIVE ELECTRODE, ELECTRODE STRUCTURE MANUFACTURED THEREBY, AND SECONDARY BATTERY COMPRISING SAME

(71) Applicant: INDUSTRY-UNIVERSITY COOPERATION FOUNDATION HANYANG UNIVERSITY ERICA CAMPUS, Ansan-si (KR)

(72) Inventors: Jung Ho Lee, Ansan-si (KR); Sambhaji Shivaji Shinde, Ansan-si (KR); Dong Hyung Kim, Ansan-si (KR); Sung Hae Kim, Ansan-si (KR)

(73) Assignee: INDUSTRY-UNIVERSITY COOPERATION FOUNDATION HANYANG UNIVERSITY ERICA CAMPUS, Ansan-si (KR)

(21) Appl. No.: 18/472,591

(22) Filed: Sep. 22, 2023

Related U.S. Application Data
(63) Continuation of application No. PCT/KR2022/004099, filed on Mar. 23, 2022.

(30) Foreign Application Priority Data
Mar. 23, 2021 (KR) 10-2021-0037491
Mar. 23, 2022 (KR) 10-2022-0036286
Mar. 23, 2022 (KR) 10-2022-0036291

(51) Int. Cl. H01M 4/04; H01M 4/136; H01M 4/1397; H01M 4/58

(52) U.S. Cl. CPC H01M 4/0457; H01M 4/0471; H01M 4/136; H01M 4/1397; H01M 4/5805; H01M 4/5815; H01M 2004/021

(57) ABSTRACT

Provided is a method for manufacturing an electrode structure. The method for manufacturing an electrode structure may comprise the steps of: preparing a first precursor having a chalcogen element, a second precursor having phosphorus, and a third precursor having a transition metal; preparing a suspension by mixing the first precursor, the second precursor, and the third precursor in a first solvent; adding a reducing agent to the suspension and causing a reaction therebetween to produce an intermediate product; and adding the intermediate product and a surfactant to a second solvent and heat-treating under pressure, to thereby manufacture an electrode structure comprising the chalcogen element, the phosphorus, and the transition metal.

### CROSS REFERENCE TO RELATED APPLICATIONS

This is a continuation of PCT/KR2022/004099 (filed 23 Mar. 2022), which claims the benefit of Republic of Korea Patent Application KR 10-2022-0036291 (filed 23 Mar. 2022), Republic of Korea Patent Application 10-2022-0036286 (filed 23 Mar. 2022) and Republic of Korea Patent Application KR 10-2021-0037491 (filed 23 Mar. 2021). The entire disclosure of each of these priority applications is hereby incorporated by reference herein.

### BACKGROUND OF THE INVENTION

### 1. Field of the Invention

The present application relates to a method for manufacturing an electrode structure for a positive electrode, an electrode structure manufactured thereby, and a secondary battery including the same.

### 2. Description of the Prior Art

As mid-to-large high-energy applications such as electric vehicles, energy storage systems (ESS) and the like are rapidly growing beyond the existing secondary batteries for small devices and home appliances, the market value of the secondary battery industry was only about 22 billion dollars in 2018, but is expected to grow to about 118 billion dollars by 2025. As such, in order for secondary batteries to be used as medium and large-sized energy storage media, there is a demand for price competitiveness, energy density and stability which are significantly improved more than a current level.

According to the technical needs, various electrodes for secondary batteries have been developed.

For example, Korean Unexamined Patent Publication No. 10-2019-0139586 discloses an electrode for a lithium-air battery, which includes a carbon nanotube and RuO2 deposited on a surface of the carbon nanotube, in which the RuO2 is deposited on a surface defect site of the carbon nanotube; the RuO2 has a particle size of 1.0 to 4.0 nm; and the RuO2 inhibits carbon decomposition at a surface defect site of the carbon nanotube and promotes the decomposition of Li2O2 formed on the surface of the carbon nanotube.

### SUMMARY OF THE INVENTION

One technical object of the present application is to provide an electrode structure and a method for manufacturing the same.

Another technical object of the present application is to provide an electrode structure with low fabrication costs and a simple fabrication process, and a method of manufacturing the same.

Still another technical object of the present application is to provide an electrode structure with enhanced ORR, OER, and HER properties, and a method of manufacturing the same.

Still another technical object of the present application is to provide an electrode structure with long life and high stability, and a method of manufacturing the same.

Still another technical object of the present application is to provide an electrode structure for a positive electrode of a metal-air battery, and a method of manufacturing the same.

Still another technical object of the present application is to provide an electrode structure for a positive electrode of a metal-air battery with low fabrication costs and a simple fabrication process, and a method of manufacturing the same.

Still another technical object of the present application is to provide an electrode structure for a positive electrode of a metal-air battery with enhanced ORR, OER, and HER properties, and a method of manufacturing the same.

Still another technical object of the present application is to provide an electrode structure for a positive electrode of a metal-air battery with long life and high stability, and a method of manufacturing the same.

The technical objects of the present application are not limited to the above.

To solve the above technical objects, the present application may provide a method of manufacturing an electrode structure.

According to one embodiment, the method for manufacturing an electrode structure may include: preparing a first precursor having a chalcogen element, a second precursor having phosphorus, and a third precursor having a transition metal; preparing a suspension by mixing the first precursor, the second precursor, and the third precursor in a first solvent; adding a reducing agent to the suspension and causing a reaction therebetween to produce an intermediate product; and adding the intermediate product and a surfactant to a second solvent and heat-treating under pressure, so as to manufacture an electrode structure including the chalcogen element, the phosphorus, and the transition metal.

According to one embodiment, the preparing of the intermediate product may include adding the reducing agent to the suspension, and then stirring the suspension at normal temperature.

According to one embodiment, the first precursor may include at least one of dithiooxamide, thiourea, ammonium sulfide, sodium sulfide, thioacetamide, or sodium thiophosphate, the second precursor may include at least one of phosphorus acid, ifosfamide, triphenylphosphine, tetradecylphosphonic acid, or sodium thiophosphate, and the third precursor may include at least one of a transition metal chloride, a transition metal sulfide, and a transition metal nitride.

According to one embodiment, the surfactant may include at least one of Triton X-165, Triton X-100, H2SO4, HCl, hexamethylenetetramine, hexadecyltrimethylammonium bromide, ammonium sulfate, polyoxyethylene, dodecanol, tridecane, or stearic acid.

According to one embodiment, the first solvent and the second solvent may include at least one of alcohol, DMF, oleic acid, oleylamine, 1-octadecene, trioctylphosphine, ethylenediamine, pyrrolidone, tributylamine, amine-based solvent, or deionized water.

According to one embodiment, the transition metal may include at least one of Cu, Mn, Fe, Co, Ni, Zn, Mg, or Ca.

According to one embodiment, the electrode structure may be in the form of a plurality of fibrillated fibers including a plurality of stems and a plurality of branches branched off from the plurality of stems.

According to one embodiment, the intermediate product in the form of the plurality of stems may be formed in a process of adding the reducing agent to the suspension and causing a reaction therebetween, and the plurality of branches may be formed in a process of adding the intermediate product and the surfactant to the second solvent and heat-treating under pressure.

According to one embodiment, a bifunctional activity, which is a difference value between overpotentials of ORR and OER of the electrode structure, may be controlled by at least one of a type of the first precursor, a type of the second precursor, a type of the transition metal of the third precursor, a type of the surfactant, a type of the first solvent, or a type of the second solvent.

According to one embodiment, the method for manufacturing an electrode structure may include: providing a first precursor having sulfur, a second precursor having phosphorus, and a third precursor having a transition metal in a first solvent including alcohol, adding a reducing agent, stirring, and causing a reaction therebetween at normal temperature to prepare an intermediate product; and adding the intermediate product and a surfactant to a second solvent including alcohol and heat-treating under pressure to manufacture an electrode structure for a positive electrode of a secondary battery including a compound of the transition metal, sulfur, and phosphorus.

According to one embodiment, the electrode structure may include a positive electrode of a metal-air secondary battery or a lithium ion secondary battery.

According to one embodiment, the first precursor may include at least one of dithiooxamide, thioacetamide, or ammonium sulfide; the second precursor may include at least one of phosphorus acid or ifosfamide; the transition metal of the third precursor may include at least one of Cu, Fe, or Mn; and the surfactant may include at least one of Triton X-165, Triton X-100, or HCl.

To solve the above technical objects, the present application may provide an electrode structure.

According to one embodiment, in the electrode structure for a positive electrode of a secondary battery, the electrode structure may include a membrane in which a plurality of fibrillated fibers formed of a compound of a transition metal, phosphorus and sulfur form a network.

According to one embodiment, the plurality of fibers formed of a compound of a transition metal, phosphorus and sulfur may include a plurality of stems, and a plurality of branches branched off from the plurality of stems, and the membrane of the electrode structure may have a sponge structure and be flexible.

To solve the above technical objects, the present application may provide an electrode structure for a positive electrode of a secondary battery.

According to one embodiment, in an electrode structure for a positive electrode of a lithium ion secondary battery for intercalating and deintercalating lithium ions during a charge/discharge process, the electrode structure may include a compound of a transition metal, sulfur and phosphorus.

According to one embodiment, the transition metal of the electrode structure may include at least one of copper, magnesium, manganese, cobalt, iron, nickel, titanium, zinc, aluminum, or tin.

According to one embodiment, the electrode structure may include a membrane in which a plurality of fibers which are fibrillated by a plurality of stems and a plurality of branches branched off from the plurality of stems form a network.

According to one embodiment, the transition metal of the electrode structure may include copper, and the electrode structure may be represented by <Formula 1> below.

CuPₓS_{y} <Formula 1>
(wherein x+y=1, 0.3≤x≤0.7, 0.3≤y≤0.7)

According to one embodiment, the electrode structure may have a sponge structure and be flexible.

To solve the above technical objects, the present application may provide a lithium ion secondary battery.

According to one embodiment, the lithium ion secondary battery may include a positive electrode including the electrode structure of claim 1, a negative electrode on the positive electrode, and an electrolyte between the positive electrode and the negative electrode.

According to one embodiment, the negative electrode may include at least one of lithium metal, carbon or silicon.

To solve the above technical objects, the present application may provide a method for manufacturing an electrode structure for a positive electrode of a lithium ion secondary battery.

According to one embodiment, in the method for manufacturing an electrode structure for a positive electrode of a lithium ion secondary battery for intercalating and deintercalating lithium ions during a charge/discharge process, the method for manufacturing an electrode structure may include: preparing a first precursor having a chalcogen element, a second precursor having phosphorus, and a third precursor having a transition metal; preparing a suspension by mixing the first precursor, the second precursor, and the third precursor in a first solvent; adding a reducing agent to the suspension and causing a reaction therebetween to produce an intermediate product; and adding the intermediate product and a surfactant to a second solvent and heat-treating under pressure, so as to manufacture an electrode structure including the chalcogen element, the phosphorus, and the transition metal.

According to one embodiment, the first precursor may include: at least one of dithiooxamide, thiourea, ammonium sulfide, sodium sulfide, thioacetamide, or sodium thiophosphate; the second precursor may include at least one of phosphorus acid, ifosfamide, triphenylphosphine, tetradecylphosphonic acid, or sodium thiophosphate; the third precursor may include at least one of a transition metal chloride, a transition metal sulfide, or a transition metal nitride; the surfactant may include at least one of Triton X-165, Triton X-100, H2SO4, HCl, hexamethylenetetramine, hexadecyltrimethylammonium bromide, ammonium sulfate, polyoxyethylene, dodecanol, tridecane, or stearic acid; and the first solvent and the second solvent may include at least one of alcohol, DMF, oleic acid, oleylamine, 1-octadecene, trioctylphosphine, ethylenediamine, pyrrolidone, tributylamine, amine-based solvent, or deionized water.

According to one embodiment, the preparing of the intermediate product may include adding the reducing agent to the suspension, and then stirring the suspension at normal temperature.

According to an embodiment of the present application, a method for manufacturing an electrode structure can include: preparing a first precursor having a chalcogen element, a second precursor having phosphorus, and a third precursor having a transition metal; preparing a suspension by mixing the first precursor, the second precursor, and the third precursor in a first solvent; adding a reducing agent to the suspension and causing a reaction therebetween to produce an intermediate product; and adding the intermediate product and a surfactant to a second solvent and heat-treating under pressure, so as to manufacture an electrode structure including the chalcogen element, the phosphorus, and the transition metal.

Accordingly, the process of manufacturing the electrode structure can be simplified, and the electrode structure can be easily fabricated at low cost.

In addition, the electrochemical properties of the electrode structure can be controlled according to a type of the first precursor, a type of the second precursor, a type of the transition metal of the third precursor, a type of the first solvent and the second solvent, and a type of the surfactant, which are used in manufacturing of the electrode structure.

Furthermore, the electrode structure may consist of the membrane in which the plurality of fibers form a network, have a flexible sponge structure, and have high ORR, OER and HER properties. Due to the high electrochemical properties of the electrode structure, the charge/discharge capacity and life property of a secondary battery, which uses the electrode structure as the positive electrode, may be improved.

An electrode structure for a positive electrode of a lithium ion secondary battery according to an embodiment of the present application may include a compound of a transition metal, sulfur, and phosphorus. In other words, the electrode structure may be formed of a non-lithium metal compound without containing lithium, thereby providing a site capable of intercalating and deintercalating lithium ions in a process of charging and discharging a lithium ion secondary battery. The electrode structure may not include a high-priced metal such as nickel, lithium, or cobalt, thereby reducing the manufacturing cost of the electrode structure and stably manufacturing the electrode structure in large quantities.

In addition, the electrode structure may be manufactured by preparing a first precursor having a chalcogen element, a second precursor having phosphorus, and a third precursor having a transition metal; preparing a suspension by mixing the first precursor, the second precursor, and the third precursor in a first solvent; adding a reducing agent to the suspension and causing a reaction therebetween to produce an intermediate product; and adding the intermediate product and a surfactant to a second solvent and heat-treating under pressure. Accordingly, the process of manufacturing the electrode structure can be simplified, and the electrode structure can be easily fabricated at low cost.

In addition, the electrochemical properties of the electrode structure can be controlled according to a type of the first precursor, a type of the second precursor, a type of the transition metal of the third precursor, a type of the first solvent and the second solvent, and a type of the surfactant, which are used in manufacturing of the electrode structure.

Furthermore, the electrode structure may consist of the membrane in which the plurality of fibers form a network and may have a flexible sponge structure.

### BRIEF DESCRIPTION OF THE DRAWINGS

FIG. 1 is a flowchart for explaining a method of manufacturing an electrode structure for a positive electrode according to an embodiment of the present application.

FIG. 2 is a view for explaining a process of manufacturing an electrode structure for a positive electrode of a metal-air battery according to an embodiment of the present application.

FIG. 3 is a view showing pictures of an electrode structure manufactured according to Experimental Example 1 of the present application.

FIG. 4 is a stress-strain graph of an electrode structure manufactured according to Experimental Example 1 of the present application.

FIG. 5 is an XRD graph of an electrode structure manufactured according to Experimental Example 1 of the present application.

FIG. 6 is a view showing SEM pictures of an electrode structure according to Experimental Example 1 of the present application.

FIG. 7 is a view showing TEM pictures of an electrode structure according to Experimental Example 1 of the present application.

FIG. 8 is a view showing a simulation and a lattice fringe image of an atomic structure of an electrode structure according to Experimental Example 1 of the present application.

FIG. 9 is an SEAD pattern of an electrode structure according to Experimental Example 1 of the present application.

FIG. 10 is a view showing HAADF-STEM images of an electrode structure according to Experimental Example 1 of the present application.

FIG. 11 provides graphs for explaining a specific area and a pore of an electrode structure according to Experimental Example 1 of the present application.

FIG. 12 is a view showing the results of TGA measurement of an electrode structure according to Experimental Example 1 of the present application.

FIG. 13 is a graph showing a comparison of chemical durability of an electrode structure according to Experimental Example 1 of the present application and Pt/C electrode.

FIG. 14 is a graph of LSV and CV according to the number of cycles for explaining the ORR properties of an electrode structure according to Experimental Example 1 of the present application.

FIG. 15 is a graph of CV and LSV according to the number of cycles of the Pt/C electrode.

FIG. 16 is a graph showing a chronoamperometric measurement and Faradaic efficiency measurement for explaining the ORR properties of an electrode structure according to Experimental Example 1 of the present application and the Pt/C electrode.

FIG. 17 is an LSV graph according to the number of cycles for explaining the OER properties of an electrode structure according to Experimental Example 1 of the present application and RuO2 electrode.

FIG. 18 is a graph of showing a chronoamperometric measurement and Faradaic efficiency measurement for explaining the OER properties of an electrode structure according to Experimental Example 1 of the present application and the RuO2 electrode.

FIG. 19 is an LSV graph according to the number of cycles for explaining the HER properties of an electrode structure according to Experimental Example 1 of the present application and Pt/C electrode.

FIG. 20 is a graph showing an in-situ XRD measurement of an electrode structure according to Experimental Example 1 in a charged/discharged state of a secondary battery according to Experimental Example 1 of the present application.

FIG. 21 is an HRTEM picture showing an electrode structure according to Experimental Example 1 in a charged/discharged state of a secondary battery according to Experimental Example 1 of the present application.

FIG. 22 is a Cu K-edge XANES spectral graph of an electrode structure according to Experimental Example 1 in a charged/discharged state of a secondary battery according to Experimental Example 1 of the present application.

FIG. 23 is an S K-edge and P L-edge XANES spectral graph of an electrode structure according to Experimental Example 1 in a charged/discharged state of a secondary battery according to Experimental Example 1 of the present application.

FIG. 24 is S L3,2-edge XANES spectra of an electrode structure according to Experimental Example 1 in a charged/discharged state of a secondary battery according to Experimental Example 1 of the present application.

FIG. 25 is S 2p XPS spectra of an electrode structure according to Experimental Example 1 in a charged/discharged state of a secondary battery according to Experimental Example 1 of the present application.

FIG. 26 is P 2p XPS spectra of an electrode structure according to Experimental Example 1 in a charged/discharged state of a secondary battery according to Experimental Example 1 of the present application.

FIG. 27 is an HRTEM picture of an electrode structure according to Experimental Example 1 in a charged/discharged state of a secondary battery according to Experimental Example 1 of the present application.

FIG. 28 is a graph showing an evaluation of ORR, OER, and HER properties according to a composition ratio of P and S in an electrode structure according to Experimental Example 1 of the present application.

FIG. 29 is a graph showing a comparison of discharge voltage according to a current density of a zinc-air battery including an electrode structure according to Experimental Example 1 of the present application.

FIG. 30 is a graph for explaining a charge/discharge capacity of a zinc-air battery according to Experimental Example 1 of the present application.

FIG. 31 is a graph showing a measurement of a voltage value according to the number of charges/discharges of a zinc-air battery according to Experimental Example 1 of the present application.

FIG. 32 is a graph showing a measurement of bifunctional activity of electrode structures according to Experimental Examples 4-1-1 and 4-1-5 of the present application.

FIG. 33 is a graph showing a measurement of bifunctional activity of electrode structures according to Experimental Examples 4-2-1 and 4-2-5 of the present application.

FIG. 34 is a graph showing a measurement of bifunctional activity of electrode structures according to Experimental Examples 4-3-1 and 4-3-6 of the present application.

FIG. 35 is a graph showing a measurement of bifunctional activity of electrode structures according to Experimental Examples 4-4-1 and 4-4-6 of the present application.

FIG. 36 is a view showing an SEM picture of an electrode structure according to Experimental Examples 4-5-1 to 4-5-6 of the present application.

FIG. 37 is a graph showing a measurement of bifunctional activity of electrode structures according to Experimental Examples 4-5-1 and 4-5-8 of the present application.

FIG. 38 is a graph showing a result of charging and discharging a lithium ion secondary battery including an electrode structure according to Experimental Example 4 of the present application.

### DETAILED DESCRIPTION OF THE EXEMPLARY EMBODIMENTS

Hereinafter, preferred embodiments of the present invention will be described in detail with reference to the accompanying drawings. However, the technical idea of the present invention is not limited to the embodiments described herein and may be embodied in other forms. The embodiments introduced herein are provided to sufficiently deliver the spirit of the present invention to those skilled in the art so that the disclosed contents may become thorough and complete.

In addition, in the various embodiments of the present specification, the terms such as first, second, and third are used to describe various elements, but the elements are not limited to the terms. These terms are used only to distinguish one element from another element. Accordingly, an element mentioned as a first element in one embodiment may be mentioned as a second element in another embodiment. Each of the embodiments described and illustrated herein also include their complementary embodiments. Further, the term “and/or” in the present specification is used to include at least one of the elements enumerated in the specification.

In the specification, the terms of a singular form may include plural forms unless otherwise specified. Further, the terms “including” and “having” are used to designate that the features, the numbers, the steps, the elements, or combinations thereof described in the specification are present, and are not to be understood as excluding the possibility that one or more other features, numbers, steps, elements, or combinations thereof may be present or added. In addition, the term “connection” used herein may include the meaning of indirectly connecting a plurality of components, and directly connecting a plurality of components.

Further, in the following description of the present invention, a detailed description of known functions and configurations incorporated herein will be omitted when it may make the subject matter of the present invention unnecessarily unclear.

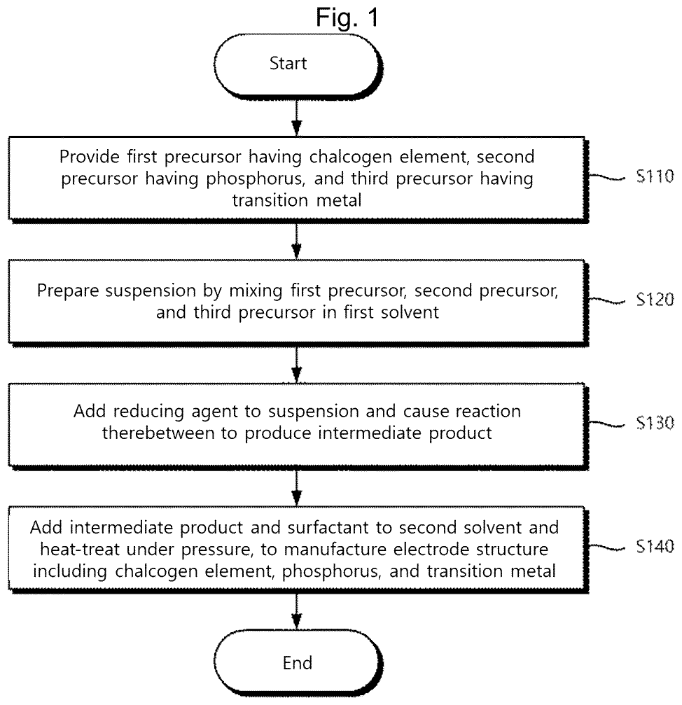

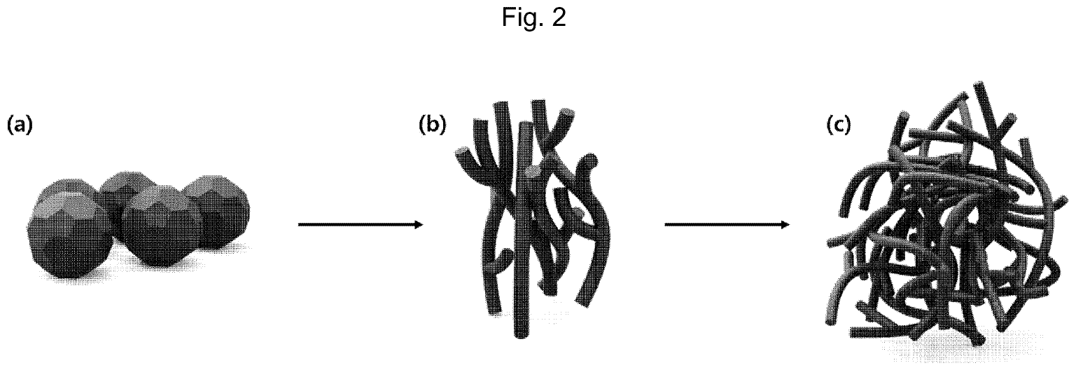

FIG. 1 is a flowchart for explaining a method of manufacturing an electrode structure according to an embodiment of the present application, and FIG. 2 is a view for explaining a process of manufacturing an electrode structure according to an embodiment of the present application.

Referring to FIGS. 1 and 2, a first precursor having a chalcogen element, a second precursor having phosphorus, and a third precursor having a transition metal may be prepared (S110)

According to one embodiment, the chalcogen element may include sulfur. In this case, for example, the first precursor may include at least one of dithiooxamide, dithiobiuret, dithiouracil, acetylthiourea, thiourea, N-methylthiourea, bis(phenylthio)methane, 2-imino-4-thiobiuret, N,N′ ammonium sulfide, methyl methanesulfonate, sulfur powder, sulphates, N,N-dimethylthioformamide, Davy reagent methyl, sodium sulfide, thioacetamide, or sodium thiophosphate.

Alternatively, according to another embodiment, the chalcogen element may include at least one of oxygen, selenium, or tellurium.

For example, the second precursor may include at least one of tetradecylphosphonic acid, ifosfamide, octadecylphosphonic acid, hexylphosphonic acid, trioctylphosphine, phosphorus acid, triphenylphosphine, ammonium phosphide, pyrophosphates, Davy reagent methyl, cyclophosphamide monohydrate, phosphorus trichloride, phosphorus(V) oxychloride, thiophosphoryl chloride, phosphorus pentachloride, phosphorus pentasulfide, ifosfamide, triphenylphosphine, or sodium thiophosphate.

According to one embodiment, different heterogeneous types including phosphorus may be used as the second precursor. For example, a mixture of tetradecylphosphonic acid and ifosfamide at a ratio of 1:1 (M %) may be used as the second precursor. Accordingly, a stoichiometric ratio of the transition metal, phosphorus, and the chalcogen element may be controlled to 1:1:1. As a result, as will be described later, the positive electrode according to an embodiment of the present application may have a covellite structure, and the electrochemical properties of the positive electrode may be improved.

Alternatively, according to another embodiment, unlike the above, ifosfamide may be used alone, or phosphorus acid may be used alone as the second precursor.

According to one embodiment, the transition metal may include copper. In this case, for example, the third precursor may include at least one of copper chloride, copper(II) sulfate, copper(II) nitrate, copper selenide, copper oxychloride, cupric acetate, copper carbonate, copper thiocyanate, copper sulfide, copper hydroxide, copper naphthenate, or copper(II) phosphate.

Alternatively, according to another embodiment, the transition metal may include at least one of magnesium, manganese, cobalt, iron, nickel, titanium, zinc, calcium, aluminum, or tin.

The third precursor including the transition metal may include at least one of a transition metal chloride, a transition metal sulfide, or a transition metal nitride.

According to one embodiment, a bifunctional activity, which is a difference value between overpotentials of ORR and OER of the electrode structure to be described later, may be controlled by a type of the first precursor, a type of the second precursor, and a type of the transition metal of the third precursor.

A suspension may be prepared by mixing the first precursor, the second precursor, and the third precursor in a first solvent.

According to one embodiment, the first solvent may include at least one of alcohol (for example, ethanol, methanol, propanol, butanol, pentanol, etc.), DMF, oleic acid, oleylamine, 1-octadecene, trioctylphosphine, ethylenediamine, pyrrolidone, tributylamine, amine-based solvent, or deionized water.

According to one embodiment, a direction of crystal plane of the electrode structure to be described later may be controlled according to a type of the solvent and a mixing ratio. In other words, according to the type of the solvent and the mixing ratio, whether a crystal plane 101 is developed or not in the electrode structure may be controlled, and thus a bifunctional activity value, which is the electrochemical property of the electrode structure, may be controlled.

According to one embodiment, the solvent may be selected (for example, mixing ethanol and ethylenediamine at a volume ratio of 1:3) so that the crystal plane 101 may be developed in the electrode structure, thereby improving the electrochemical properties (for example, ORR, OER, HER) of the electrode structure.

Subsequently, referring to FIG. 1, an intermediate product may be produced by adding a reducing agent to the suspension and causing a reaction therebetween (S130).

For example, the reducing agent may include at least one of ammonium hydroxide, ammonium chloride, or tetramethylammonium hydroxide.

After the first precursor, the second precursor, and the third precursor are mixed in the solvent, the reducing agent may be provided to perform nucleation and crystallization as shown in (a) of FIG. 2 and prepare an intermediate including a plurality of stems as shown (b) of FIG. 2.

According to one embodiment, the suspension may be heat-treated to form the intermediate product. For example, the mixture to which the reducing agent is added may be heat treated under reflux at 120° C., and then washed with deionized water and ethanol.

The reducing agent may maintain pH and increase a reaction rate while performing a function of the reducing agent during heat treatment. Accordingly, the intermediate product having the plurality of stems may be easily prepared. For example, when the transition metal is copper and the chalcogen element is sulfur, the intermediate structure may be CuPS having a covellite crystal structure.

Alternatively, according to another embodiment, the intermediate product may be prepared by a method of adding the reducing agent to the suspension and then stirring the suspension at normal temperature. In other words, the intermediate product may be prepared by a method of stirring at normal temperature without an additional heat treatment.

An electrode structure including the chalcogen element, the phosphorus, and the transition metal may be prepared by a method of adding a surfactant to the intermediate product and performing heat treatment under pressure (S140).

According to one embodiment, the intermediate product and the surfactant may be added to a second solvent, and then a pressure heat treatment process may be performed.

The second solvent may be the same as the first solvent. For example, the second solvent may include at least one of alcohol (for example, ethanol, methanol, propanol, butanol, pentanol, etc.), DMF, oleic acid, oleylamine, 1-octadecene, trioctylphosphine, ethylenediamine, pyrrolidone, tributylamine, amine-based solvent, or deionized water.

For example, the surfactant may include at least one of Triton X-165, Triton X-100, H2SO4, HCl, hexamethylenetetramine, hexadecyltrimethylammonium bromide, ammonium sulfate, polyoxyethylene, dodecanol, tridecane, or stearic acid.

According to one embodiment, a bifunctional activity, which is a difference value between overpotentials of ORR and OER of the electrode structure, may be controlled by a type of the second precursor and a type of the surfactant.

Alternatively, according to one embodiment, a chalcogen element source having the chalcogen element may be further added along with the reducing agent. Accordingly, the chalcogen element lost in the reaction process may be supplemented by the chalcogen element source, and the electrode structure having a sponge structure in which a plurality of fibrillated fibers to be described later form a network may be easily formed.

For example, when the chalcogen element is sulfur, the chalcogen element source may include at least one of sodium bisulfite, sodium sulfate, sodium sulfide, sodium thiosulfate, sodium thiomethoxide, sodium ethanethiolate, or sodium methanethiolate.

In addition, according to one embodiment, a phosphorus source may be also added together with the chalcogen element source.

According to one embodiment, a process of mixing the intermediate product and the surfactant in the second solvent may be performed in a cooled state. The reaction rate may be prevented from excessively increasing due to the heat generated in the process of adding the second reducing agent, thereby improving the electrochemical properties of the electrode structure to be described later.

As described above, a plurality of branches may branch off from the plurality of stems as shown in (c) of FIG. 2 by adding the surfactant to the intermediate product and performing heat treatment under pressure, and thus the electrode structure having a sponge structure in which a plurality of fibrillated fibers form a network may be formed.

The electrode structure having a sponge structure may be immersed in liquid nitrogen after being washed with deionized water and ethanol. Accordingly, mechanical properties and flexibility of the electrode structure having a sponge structure may be improved. Alternatively, the process of immersing in liquid nitrogen may be omitted.

In addition, after being immersed in liquid nitrogen, the electrode structure having a sponge structure may be freeze-dried, and the remaining solvents may be removed to minimize a secondary reaction.

The electrode structure may include a membrane having a sponge structure, in which a plurality of fibrillated fibers having a plurality of branches branched off from the plurality of stems form a network as described above. Accordingly, the electrode structure may have a porous structure in which a plurality of pores having a size of 1 to 2 nm are provided, and may be flexible.

In addition, according to one embodiment, as described above, the type and ratio of the solvent mixed with the first precursor, the second precursor, and the third precursor may be controlled and thus a crystal plane 101 may be developed in the electrode structure. Accordingly, upon the XRD analysis of the electrode structure, a peak value corresponding to the crystal plane 101 may have a maximum value compared with a peak value corresponding to another crystal plane. Upon the XRD measurement, a peak value corresponding to the crystal plane 101 may be observed in a range of 20 values of 19° to 21°.

The plurality of fibers forming the electrode structure may include a compound of the transition metal, phosphorus, and the chalcogen element. For example, when the transition metal is copper and the chalcogen element is oxygen, the fiber may be represented by the following <Formula 1>.

CuPₓS_{y} <Formula 1>

When the fiber forming the electrode structure is represented as above <Formula 1>, it may be x+y=1, 0.3≤x≤0.7, 0.3≤y≤0.7.

If, in above <Formula 1>, x is less than 0.3 or more than 0.7 and y is less than 0.3 or more than 0.7, ORR, OER, and HER properties of the electrode structure may be deteriorated, and thus the electrode structure may not react reversibly in a process of charging and discharging a metal-air battery including the electrode structure as a positive electrode, accordingly.

However, according to an embodiment of the present application, when the electrode structure is represented by CuPₓS_{y}, a composition ratio of P may be 0.3 or more and 0.7 or less and a composition ratio of S may be 0.3 or more and 0.7 or less. Accordingly, the ORR, OER, and HER properties of the electrode structure may be improved, and the charge/discharge property and life property of a metal-air battery, which includes the electrode structure as the positive electrode, may be improved.

When the metal-air battery including the electrode structure as a positive electrode performs charging and discharging, a lattice spacing of the fibers included in the electrode structure may be reversibly changed. Specifically, when the metal-air battery is charged, the lattice spacing may be 0.478 nm, and when the metal-air battery is discharged, the lattice spacing may be 0.466 nm. The lattice spacing of the fibers may be confirmed by the HRTEM.

According to an embodiment of the present application, the electrode structure having a membrane form in which the plurality of fibrillated fibers form a network according to a method of mixing the first precursor having the chalcogen element, the second precursor having phosphorus, and the third precursor having the transition metal, adding the reducing agent, and heat treating under pressure.

Accordingly, the electrode structure having high electrochemical properties may be manufactured by an inexpensive method.

In addition, the electrode structure may be manufactured by stirring and heat treating under pressure, and thus may be easily mass-produced and subjected to a simple manufacturing process, thereby providing the electrode structure for a positive electrode of a metal-air battery.

In addition, the electrode structure may be a non-lithium metal compound and a lithium free metal compound that does not contain lithium, and may provide a site capable of intercalating and deintercalating lithium ions in a process of charging and discharging a lithium ion secondary battery.

Accordingly, the electrode structure having high electrochemical properties may be manufactured by an inexpensive method. In other words, a positive electrode active material of a conventional lithium ion secondary battery was formed of a lithium transition metal oxide. In the case of including a high content of nickel, expensive metals such as cobalt and lithium was used. In contrast, the electrode structure according to an embodiment of the present application may not include a high-priced metal such as nickel, lithium, or cobalt, thereby stably manufacturing the electrode structure in large quantities.

Hereinafter, will be described the results of evaluating the properties of an electrode structure according to a specific experimental embodiment of the present application and a secondary battery including the same.

Manufacturing of Electrode Structure and Secondary Battery According to Experimental Example 1

Dithiooxamide was prepared as a first precursor having sulfur, a mixture of tetradecylphosphonic acid and ifosfamide (1:1 M %) was prepared as a second precursor having phosphorus, copper chloride was prepared as a third precursor having copper, and a mixture of ethanol and ethylenediamine (1:3 v/v %) was prepared as a solvent.

The first to third precursors were added to the solvent and stirred to prepare a suspension.

After that, 2.5 M % ammonium hydroxide was added as a reducing agent, stirred for two hours, and heat treated at 120° C. for six hours, after which an intermediate product was obtained, washed with deionized water and ethanol, and dried under vacuum at 50° C.

In an ice bath, the intermediate product was mixed and stirred in 20 ml of deionized water with Triton X-165 as a surfactant and sodium bisulfite as an sulfur element source. After that, the resulting mixture was heat treated under pressure at 120° C. for 24 hours and mixed in M-methyl-pyrrolidone to prepare a slurry, which was then coated and peeled off, thereby preparing a membrane in which a plurality of fibrillated fibers formed of a compound of copper, phosphorus and sulfur form a network.

The membrane was washed with deionized water and ethanol to adjust to neutral pH, stored at −70° C. for two hours, immersed in liquid nitrogen, and freeze-dried in vacuum, so as to manufacture a CuPS electrode structure according to Experimental Example 1 in which a crystal plane 101 is developed.

In the process of manufacturing the electrode structure according to Experimental Example 1, a ratio of the first precursor having sulfur and the second precursor having phosphorus was controlled to adjust a ratio of P and S in CuPS at 0.1:0.9, 0.2:0.8, 03:0.7, 0.5:0.5, 0.7.0.3, and 0.9:0.1, respectively.

A zinc-air battery according to Experimental Example 1 was manufactured by using the CuPS electrode structure according to Experimental Example 1 as a positive electrode, laminating a solid electrolyte according to Experimental Example to be described later, and a patterned zinc negative electrode.

Manufacturing of Solid Electrolyte According to Experimental Example

Acetobacter xylinum was provided as a bacterial strain, and a chitosan derivative was provided. The chitosan derivative was prepared by dissolving 1 g of chitosan chloride in 1% (v/v) aqueous acetic acid, treating the resulting suspension with 1 M glycidyltrimethylammonium chloride at 65° C. for 24 hours in an N₂ atmosphere, precipitating, and filtering multiple times with ethanol.

A Hestrin-Schramm (HS) culture medium containing pineapple juice (2% w/v), yeast (0.5% w/v), peptone (0.5% w/v), disodium phosphate (0.27% w/v), citric acid (0.015% w/v), and the chitosan derivative (2% w/v) was prepared and steam-sterilized at 121° C. for 20 minutes. In addition, Acetobacter xylinum was activated in a pre-cultivation Hestrin-Schramm (HS) culture medium at 30° C. for 24 hours, and then acetic acid was added to maintain pH 6.

After that, Acetobacter xylinum was cultured in the Hestrin-Schramm (HS) culture medium at 30° C. for seven days.

The harvested bacterial pellicle was washed with deionized water to neutralize the pH of the supernatant and dehydrated in vacuum at 105° C. The resulting cellulose was demineralized by using 1 N HCl for 30 minutes (a mass ratio of 1:15, w/v) to remove an excessive amount of reagent, and then was purified a plurality of times by centrifugation with deionized water until the supernatant reached a neutral pH. Finally, all solvents were evaporated at 100° C. to prepare a base composite fiber (chitosan-bacterial cellulose (CBC)).

2 g of the base composite fiber dispersed in a 2 mM TEMPO aqueous solution was reacted with NaBr (1.9 mM). 5 mM NaClO was used as an oxidizing agent.

The reaction suspension was stirred with ultrasonic waves and reacted at room temperature for three hours. The pH of the suspension was maintained at 10 by successive addition of 0.5 M NaOH solution. Then, 1 N HCL was added to the suspension to keep the pH neutral for three hours. The oxidized pulp produced in the suspension was washed three times with 0.5 N HCl, and the supernatant was brought to a neutral pH with deionized water.

The washed pulp was exchanged with acetone and toluene for 30 minutes and dried to evaporate the solvent, and finally a first composite fiber (oCBC) fiber was obtained.

1 g of the base composite fiber dispersed in N,N-dimethylacetamide (35 ml) solution was reacted with LiBr (1.25 g) suspension while being stirred for 30 minutes. N-bromosuccinimide (2.1 g) and triphenylphosphine (3.2 g) were used as a coupling agent. The two reaction mixtures were stirred for 10 minutes and reacted at 80° C. for 60 minutes.

Then, the reaction suspension was cooled to room temperature, added to deionized water, filtered, rinsed with deionized water and ethanol, and freeze-dried to obtain a brominated base composite (bCBC) fiber.

The brominated base composite fiber was dissolved in 100 ml of N,N-dimethylformamide and reacted with 1.2 g of 1,4-diazabicyclo[2.2.2]octane coupling agent.

After that, the mixture was subjected to ultrasonic treatment for 30 minutes, and then reacted at room temperature for 24 hours. The resulting solution was mixed with diethyl ether, washed five times with diethyl ether/ethyl acetate, and freeze-dried to obtain a second composite fiber (covalently quaternized CBC (qCBC)).

The first composite fiber (oCBC) and the second composite fiber (qCBC) were dissolved in a mixture of methylene chloride, 1,2-propanediol and acetone (8:1:1 v/v/v %) at the same weight ratio by using ultrasonic waves, and then 1 wt % of glutaraldehyde as a crosslinking agent and 0.3 wt % of N,N-diethyl-N-methyl-N-(2-methoxyethyl) ammonium bis(trifluoromethanesulfonyl)imide were added as an initiator.

A vacuum chamber (200 Pa) was used to remove air bubbles from the gel suspension and cast on glass at 60° C. for six hours. A composite fiber membrane was peeled off while being coagulated with deionized water, rinsed with deionized water, and vacuum dried.

Solid electrolyte (CBCs) were prepared through ion exchange with 1 M KOH aqueous solution and 0.1 M ZnTFSI at normal temperature for six hours, respectively. After that, washing and immersion processes were performed with deionized water in an N₂ atmosphere in order to avoid a reaction with CO₂ and a carbonate formation.

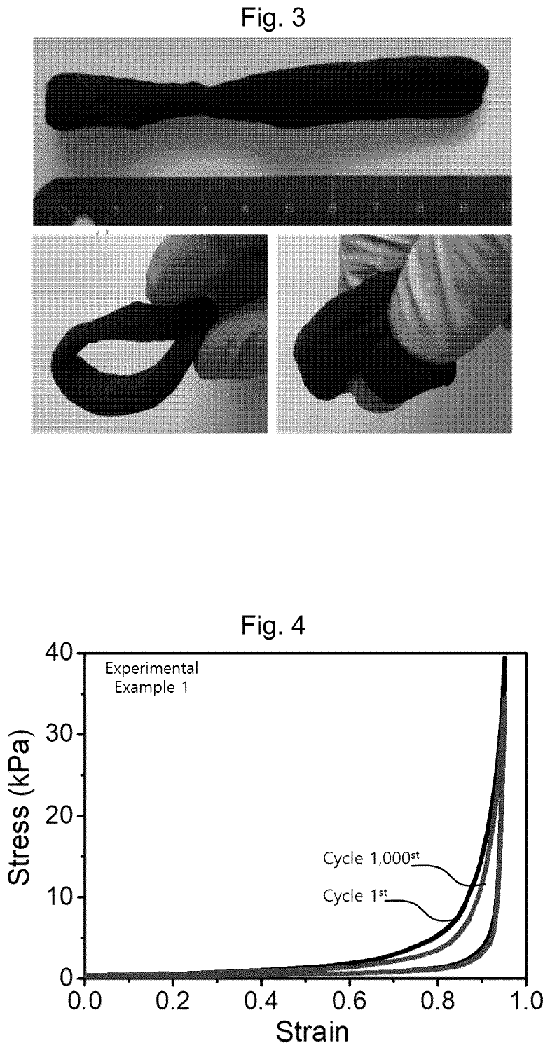

FIG. 3 is a view showing pictures of an electrode structure manufactured according to Experimental Example 1 of the present application, and FIG. 4 is a stress-strain graph of an electrode structure manufactured according to Experimental Example 1 of the present application.

Referring to FIGS. 3 and 4, the electrode structure (CuP_{0.5}S_{0.5}) manufactured according to Experimental Example 1 described above was photographed, and stress-strain was measured under the conditions of relative humidity of about 40% and normal temperature.

As shown in FIG. 3, it can be confirmed that the electrode structure according to Experimental Example 1 has a length of about 10 cm and is flexible.

In addition, as shown in FIG. 4, it can be confirmed that the electrode structure according to Experimental Example 1 has a high recovery rate of about 94% and has high flexibility, compressibility, and elasticity even after applying stress for 1000 times.

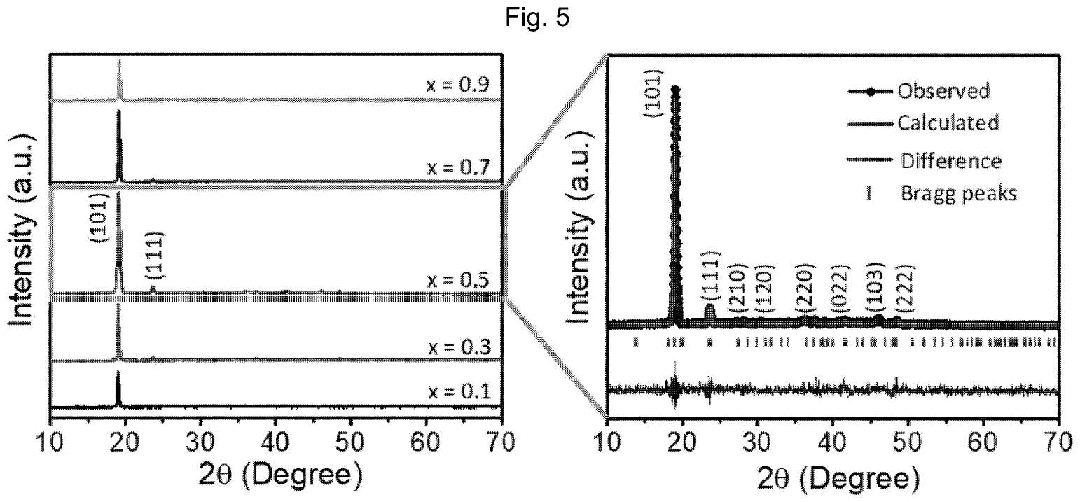

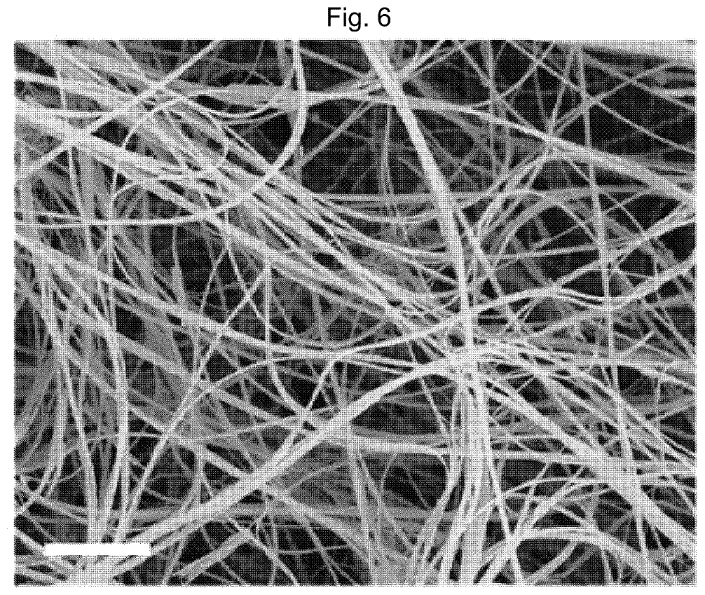

FIG. 5 is an XRD graph of an electrode structure manufactured according to Experimental Example 1 of the present application.

Referring to FIG. 5, an XRD measurement was performed for a CuPS electrode structure having various P and S composition ratios according to Experimental Example 1.

As can be confirmed from FIG. 5, it can be confirmed that a pattern changes according to a composition ratio of P and S in the CuPS electrode structures according to Experimental Examples, and it can be seen that a size of a peak corresponding to the crystal plane 101 is larger than a size of a peak corresponding to another crystal plane.

In addition, it can be seen that the CuPS positive electrode of Experimental Example 1 has a covellite phase with an orthorhombic crystal structure Pnm21 space group.

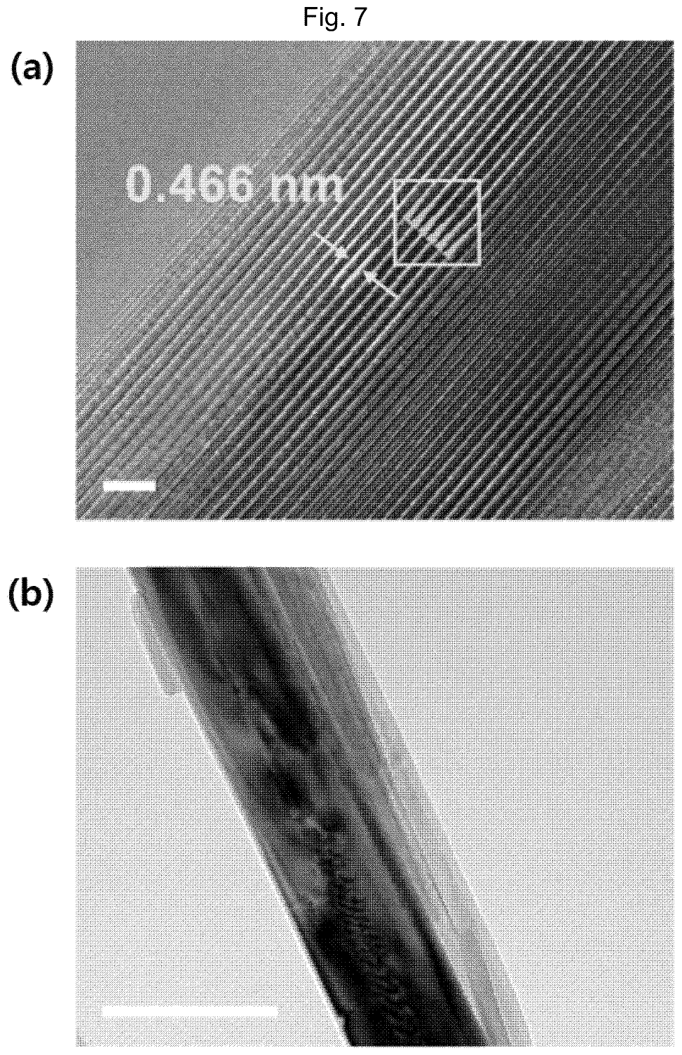

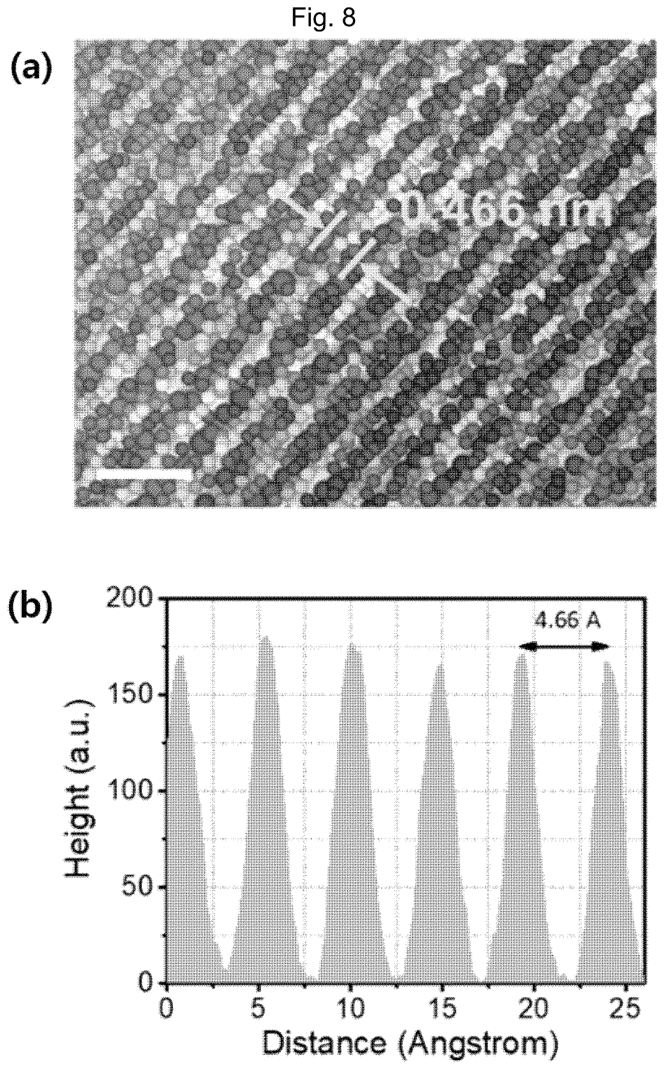

FIG. 6 is a view showing an SEM picture of an electrode structure according to Experimental Example 1 of the present application, FIG. 7 is a view showing TEM pictures of an electrode structure according to Experimental Example 1 of the present application, and FIG. 8 is a view showing a simulation and a lattice fringe image of an atomic structure of an electrode structure according to Experimental Example 1 of the present application.

Referring to FIGS. 6 to 8, SEM and TEM pictures were taken of the CuPS electrode structure (CuP_{0.5}S_{0.5}) according to Experimental Example 1, and a simulation and a lattice fringe image of an atomic structure of an electrode structure were displayed. (a) of FIG. 7 is a high-resolution (scale bar 2 nm) TEM picture of the electrode structure of Experimental Example 1, (b) of FIG. 7 is a low-resolution (scale bar 30 nm) TEM picture of the electrode structure of Experimental Example 1, (a) of FIG. 8 is a simulation showing an atomic arrangement of the crystal plane 101 of the electrode structure of Experimental Example 1, and (b) of FIG. 8 is a topographic plot profile of a lattice fringe image of the electrode structure of Experimental Example 1.

As can be understood from FIG. 6, it can be confirmed that a plurality of fibers form a network in the electrode structure of Experimental Example 1.

In addition, as can be understood from FIGS. 7 and 8, it can be confirmed that a lattice spacing of the electrode structure of Experimental Example 1 is 0.466 nm.

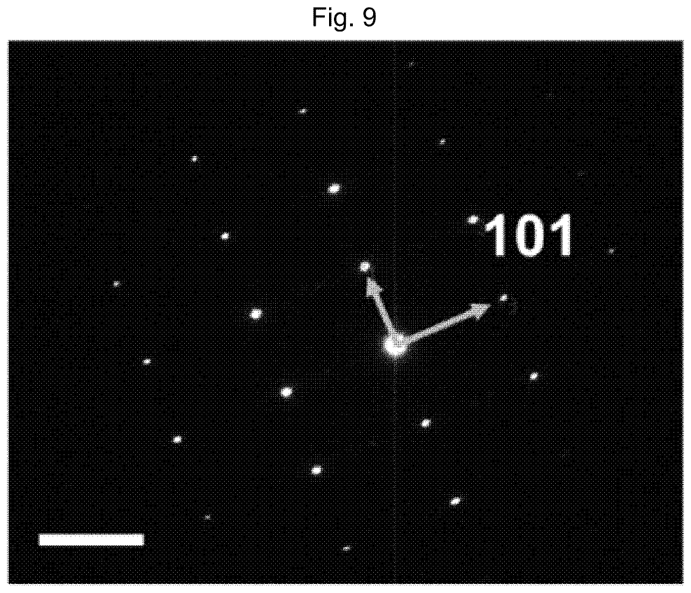

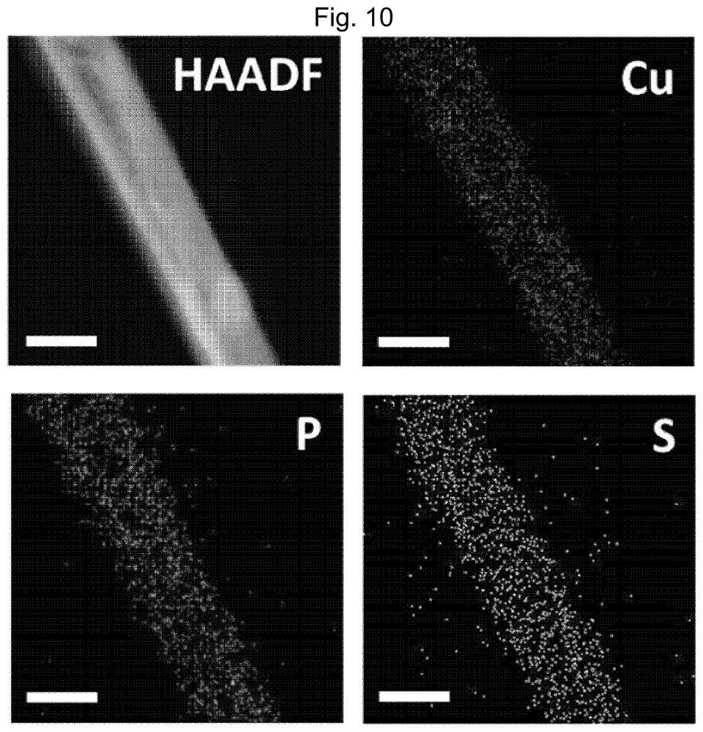

FIG. 9 is an SEAD pattern of an electrode structure according to Experimental Example 1 of the present application, and FIG. 10 is a view showing HAADF-STEM images of an electrode structure according to Experimental Example 1 of the present application.

Referring to FIGS. 9 and 10, a SEAD pattern (scale 2 nm⁻¹) was obtained for the plane 101 of the CuPS electrode structure (CuP_{0.5}S_{0.5}) according to Experimental Example 1 described above, a high angle annular dark field canning transmission electron microscopy (HAADF-STEM) image was taken, and mapping results are shown for Cu, P, and S.

As can be understood from FIGS. 9 and 10, it can be seen that the electrode structure of Experimental Example 1 has an orthorhombic crystal structure having a crystal plane 101 and is formed of a compound of Cu, P and S.

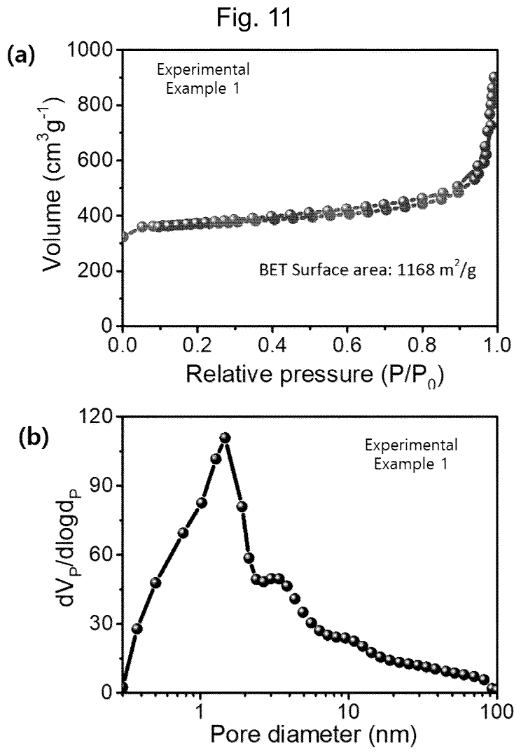

FIG. 11 provides graphs for explaining a specific area and a pore of an electrode structure according to Experimental Example 1 of the present application.

Referring to FIG. 11, a BET surface area of a CuPS electrode structure (CuP_{0.5}S_{0.5}) according to Experimental Example 1 described above was measured. It can be confirmed that an electrode structure according to Experimental Example 1 has a porous structure with a specific surface area of 1168 m²/g and has a large amount of pores having a size of 1 to 2 nm.

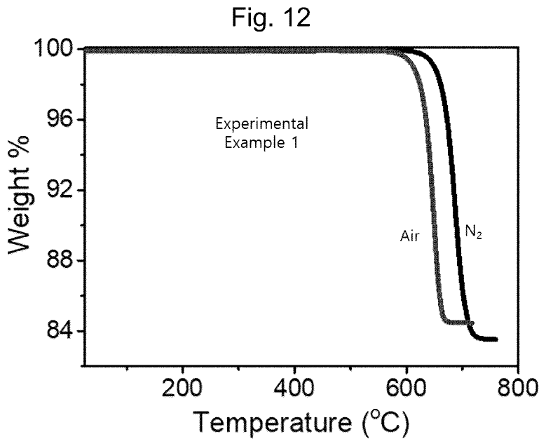

FIG. 12 is a view showing the results of TGA measurement of an electrode structure according to Experimental Example 1 of the present application.

Referring to FIG. 12, a TGA analysis was performed on the CuPS electrode structure (CuP_{0.5}S_{0.5}) according to Experimental Example 1 while a temperature was raised to 5° C. in a nitrogen and atmospheric gas atmosphere.

As can be understood from FIG. 12, it can be seen that the electrode structure according to Experimental Example 1 maintains a stable state. In the nitrogen atmosphere, a weight was lost at 605° C. to 732° C., and in the atmospheric gas atmosphere, a weight was lost at 565° C. to 675° C. Compared with the atmospheric gas atmosphere, it can be seen that a state is a little more stable in the nitrogen gas atmosphere, which is due to the formation of CuO in the electrode structure according to Experimental Example 1.

In conclusion, it can be confirmed that the electrode structure according to Experimental Example 1 has high thermal stability of the orthorhombic crystal structure.

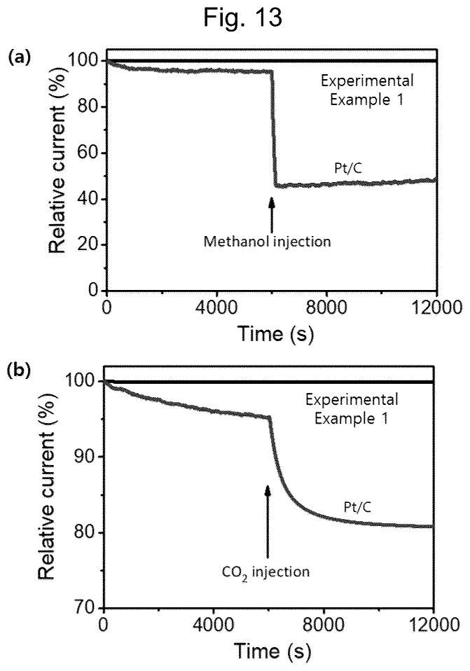

FIG. 13 is a graph showing a comparison of chemical durability of an electrode structure according to Experimental Example 1 of the present application and Pt/C electrode.

Referring to FIG. 13, chemical durability was measured by injecting methanol (2 M) and CO₂ (10 V %) into the electrode structure according to Experimental Example 1 and the commercially available Pt/C electrode at 1600 rpm by using 0.1 M KOH. CuP_{0.5}S_{0.5} was used as the electrode structure of Experimental Example 1.

As shown in FIG. 13, it can be confirmed that the electrode structure according to Experimental Example 1 is stably driven even after methanol and CO₂ are injected. In contrast, in the case of the Pt/C electrode, it can be confirmed that a current value is remarkably lowered when methanol or C02 is injected.

In conclusion, it can be seen that the CuPS electrode structure according to Experimental Example 1 of the present application has a high ORR property as well as excellent chemical resistance compared with the commercialized Pt/C electrode. Accordingly, it can be seen that the CuPS electrode structure according to Experimental Example 1 of the present application can be stably utilized in an alkaline environment.

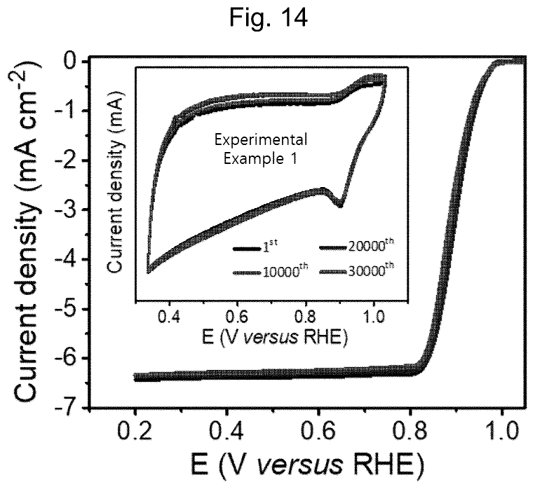

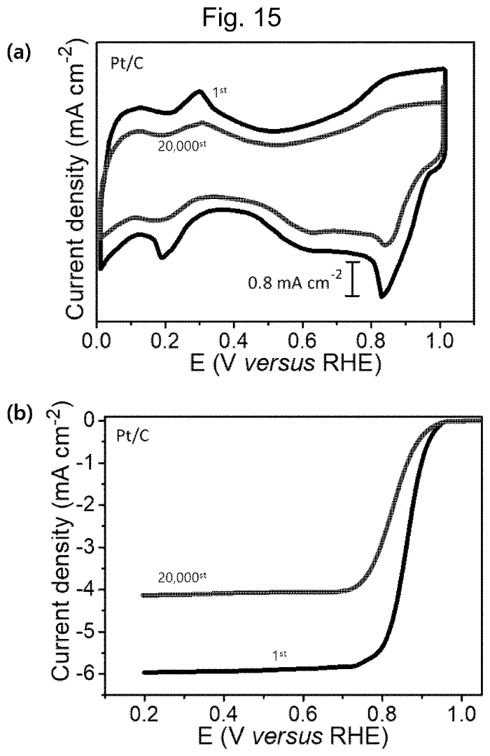

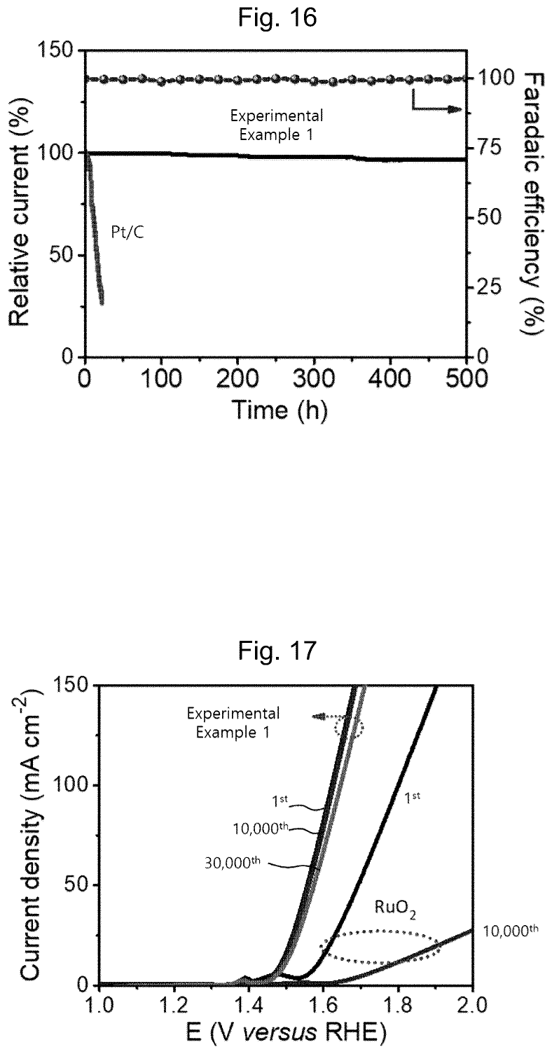

FIG. 14 is a graph of LSV and CV according to the number of cycles for explaining the ORR properties of an electrode structure according to Experimental Example 1 of the present application, FIG. 15 is a graph of CV and LSV according to the number of cycles of the Pt/C electrode, and FIG. 16 is a graph showing a chronoamperometric measurement and Faradaic efficiency measurement for explaining the ORR properties of an electrode structure according to Experimental Example 1 of the present application and the Pt/C electrode.

Referring to FIGS. 14 to 16, LSV and CV measurements were performed according to the number of cycles for the CuPS electrode structure according to Experimental Example 1 and the commercially available Pt/C electrode by using 0.1 M KOH and under oxygen conditions. In addition, the CuPS electrode structure according to Experimental Example 1 and the Pt/C electrode were measured by a chronoamperometric method under 0.9 V conditions, and the Faraday efficiency was measured for the CuPS electrode according to Experimental Example 1. CuP_{0.5}S_{0.5} was used as the electrode structure of Experimental Example 1.

As can be understood from FIGS. 14 to 16, it can be confirmed that the electrode structure according to Experimental Example 1 is stably driven without a substantial change even after 30,000 charge/discharge cycles are performed. In addition, it can be confirmed that the structure is stably driven without a substantial change for about 500 hours and has a Faraday efficiency of about 98% or more.

In contrast, in the case of the Pt/C electrode, it can be confirmed that a current density value is remarkably reduced and properties are remarkably deteriorated compared with the electrode structure of Experimental Example 1 as cycles are performed.

In conclusion, it can be seen that the CuPS electrode structure according to Experimental Example 1 has a high ORR property and excellent chemical resistance compared with the commercialized Pt/C electrode.

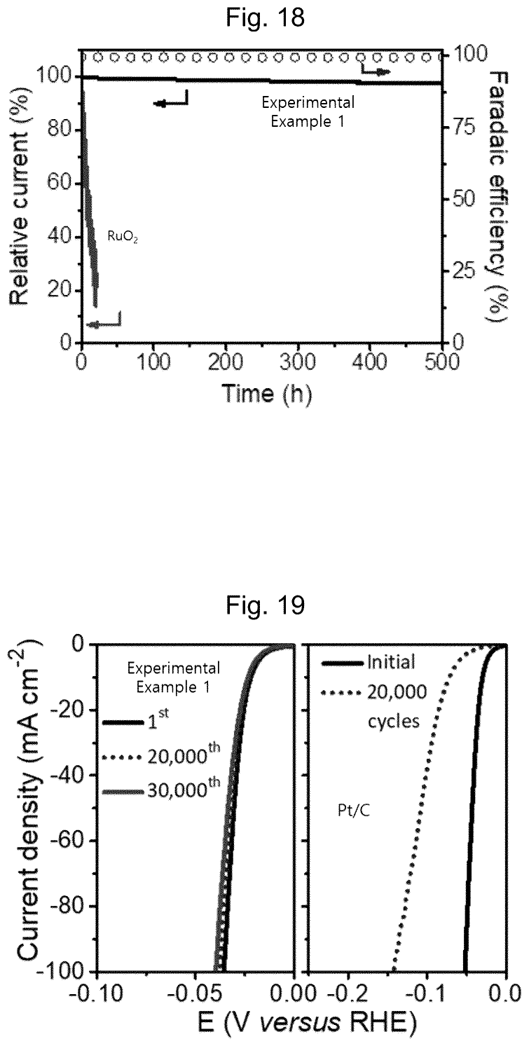

FIG. 17 is an LSV graph according to the number of cycles for explaining the OER properties of an electrode structure according to Experimental Example 1 of the present application and RuO₂ electrode, and FIG. 18 is a graph of showing a chronoamperometric measurement and Faradaic efficiency measurement for explaining the OER properties of an electrode structure according to Experimental Example 1 of the present application and the RuO₂ electrode.

Referring to FIGS. 17 and 18, LSV measurement was performed according to the number of cycles for the CuPS electrode structure according to Experimental Example 1 and the commercially available RuO₂ electrode at 1600 rpm and by using 0.1 M KOH. In addition, the CuPS electrode structure according to Experimental Example 1 and the RuO₂ electrode were measured by a chronoamperometric method under 1.5 V conditions, and the Faraday efficiency was measured for the CuPS electrode according to Experimental Example 1. CuP_{0.5}S_{0.5} was used as the electrode structure of Experimental Example 1.

As can be understood from FIGS. 17 to 18, it can be confirmed that the electrode structure according to Experimental Example 1 is stably driven without a substantial change even after 30,000 cycles are performed. In addition, it can be confirmed that the structure is stably driven without a substantial change for about 500 hours and has a Faraday efficiency of about 99% or more.

In contrast, in the case of the RuO₂ electrode, it can be confirmed that the overpotential rapidly increases as the cycle is performed, a current density value rapidly decreases, and a loss of 85% or more occurs after 24 hours.

In conclusion, it can be seen that the CuPS electrode structure according to Experimental Example 1 has a higher ORR property and a longer life compared with the commercialized RuO₂ electrode.

FIG. 19 is an LSV graph according to the number of cycles for explaining the HER properties of an electrode structure according to Experimental Example 1 of the present application and Pt/C electrode.

Referring to FIG. 19, an LSV measurement was performed according to the number of cycles for the CuPS electrode structure according to Experimental Example 1 and the Pt/C electrode.

As can be seen from FIG. 19, in the case of the Pt/C electrode, it can be confirmed that the overpotential greatly increases after 20,000 cycles, so that the HER property is rapidly deteriorated. In contrast, it can be confirmed that the electrode structure according to Experimental Example 1 is stably driven without a substantial change even after 30,000 cycles are performed.

In conclusion, it can be seen that the CuPS electrode structure according to Experimental Example 1 has a higher HER property and a longer life compared with the commercialized Pt/C electrode.

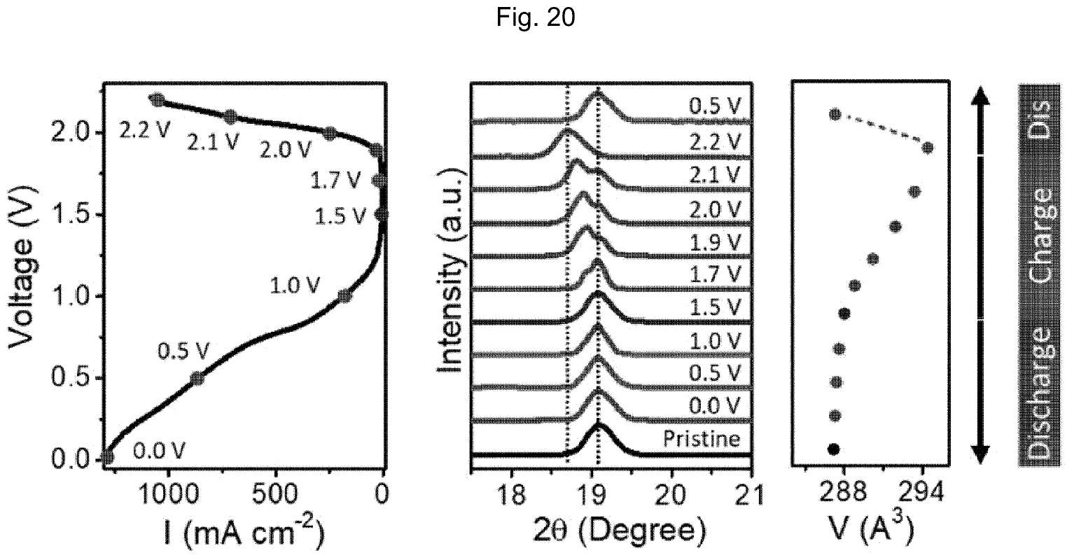

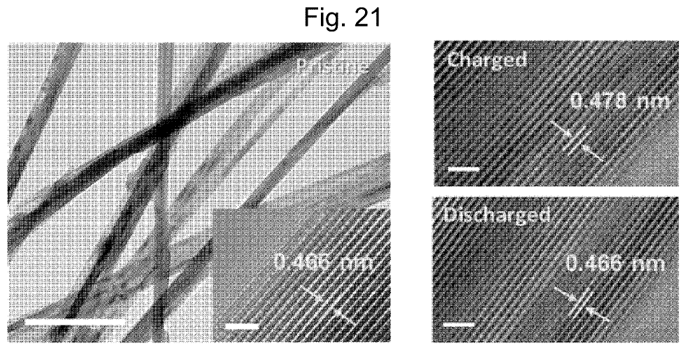

FIG. 20 is a graph showing an in-situ XRD measurement of an electrode structure according to Experimental Example 1 in a charged/discharged state of a secondary battery according to Experimental Example 1 of the present application, and FIG. 21 is an HRTEM picture showing an electrode structure according to Experimental Example 1 in a charged/discharged state of a secondary battery according to Experimental Example 1 of the present application.

Referring to FIGS. 20 and 21, an in-situ XRD measurement was performed for the electrode structure according to Experimental Example 1 in a charged/discharged state of a secondary battery according to Experimental Example 1, and a galvanostatic charge/discharge profile and a volume change in an unit cell of the electrode structure of Experimental Example 1 are also shown. In addition, an HRTEM picture of an electrode structure according to Experimental Example 1 was taken in a charged/discharged state of a secondary battery according to Experimental Example 1.

As can be understood from FIGS. 20 and 21, in the case of electrode structure of Experimental Example 1, it can be confirmed that a peak is observed in the range of 20 values of 18.5° to 19.5°, and as charging proceeds in a discharged state, a 2θ value corresponding to the peak moves to the left and decreases, and then the peak is divided into two. In addition, in case of being fully charged with 2.2V at 0.466 nm, it can be confirmed that that the lattice spacing increases to 0.478 nm and a volume of the unit cell increases from 287.2 Å 3 to 294.6 Å 3. In other words, it can be seen that a solid-solution reaction occurs while the electrode structure of Experimental Example 1 maintains an orthorhombic crystal structure during charging and discharging.

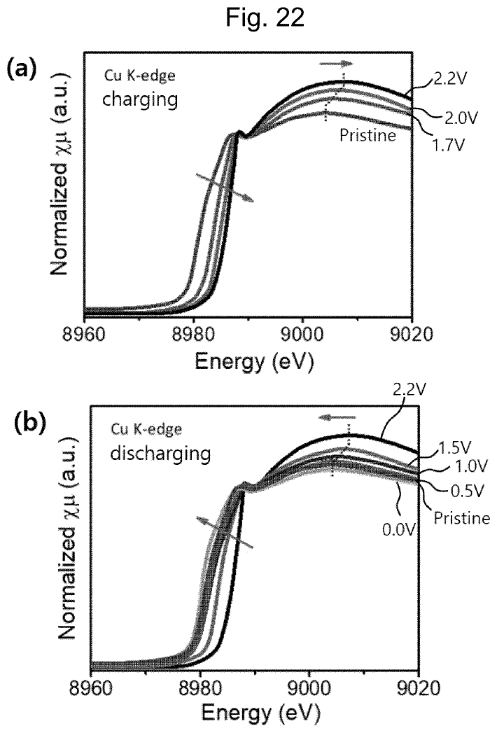

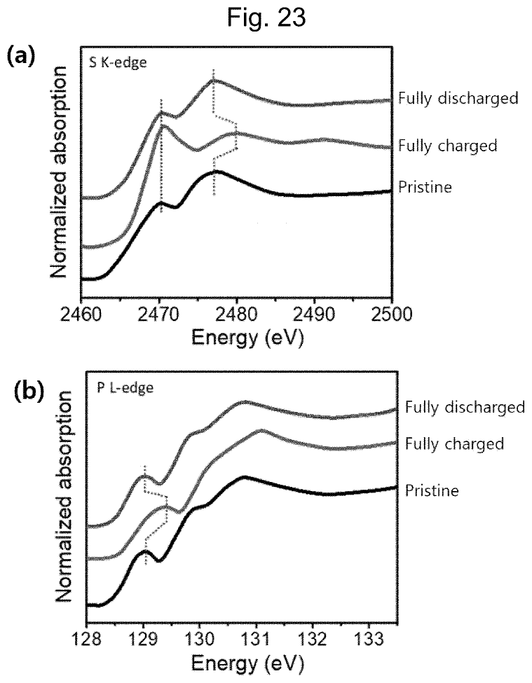

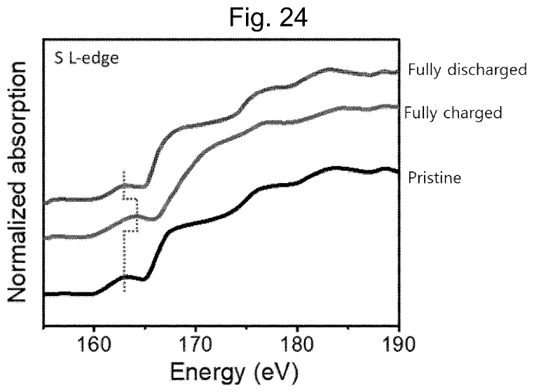

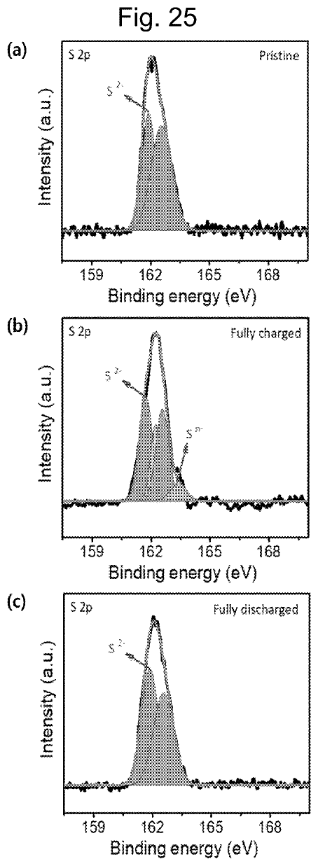

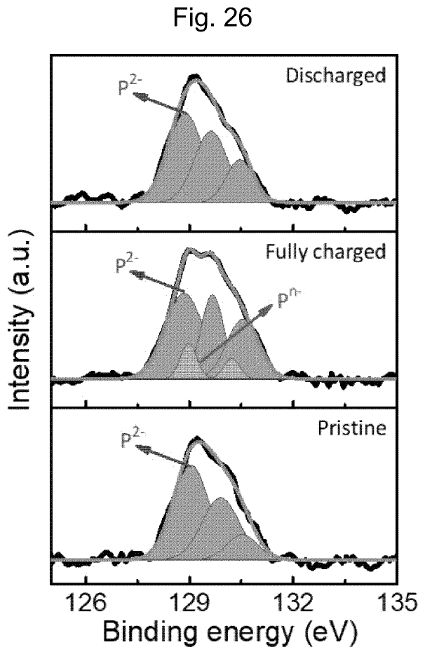

FIG. 22 is a Cu K-edge XANES spectral graph of an electrode structure according to Experimental Example 1 in a charged/discharged state of a secondary battery according to Experimental Example 1 of the present application, FIG. 23 is an S K-edge and P L-edge XANES spectral graph of an electrode structure according to Experimental Example 1 in a charged/discharged state of a secondary battery according to Experimental Example 1 of the present application, FIG. 24 is S L_{3,2}-edge XANES spectra of an electrode structure according to Experimental Example 1 in a charged/discharged state of a secondary battery according to Experimental Example 1 of the present application, FIG. 25 is S 2p XPS spectra of an electrode structure according to Experimental Example 1 in a charged/discharged state of a secondary battery according to Experimental Example 1 of the present application, and FIG. 26 is P 2p XPS spectra of an electrode structure according to Experimental Example 1 in a charged/discharged state of a secondary battery according to Experimental Example 1 of the present application.

Referring to FIGS. 22 to 26, Cu K-edge, S K-edge, P L-edge, S L-edge XANES, and S 2p XPS of an electrode structure according to Experimental Example 1 were measured according to charging/discharging of a secondary battery according to Experimental Example 1.

As can be understood from FIG. 22, a reversible conversion of Cu K-edges may be confirmed in the state of being charged from 1.7V to 2.2V and in the process of discharging from 2.2V to 0.0V.

In addition, as can be understood from (a) of FIG. 23, upon reaching a state of charge in the SK-edge spectra, the strength of the pre-edge was increased, and the broad-edge was increased about 2.9 eV.

An increase in the strength of the pre-edge may mean that an unoccupied state of sulfur higher than a Fermi level is strengthened, which may correspond to a redox reaction compensated by electrons of S 3p and Cu 3d. In addition, a shift of the broad-edge may mean a decrease in electron density from S²⁻ to S^{y-} (y<2).

In addition, as can be understood from FIGS. 24 and 25, two additional peaks for high binding energy of 162.2 to 163.3 eV may be confirmed in S 2p XPS after charging, and the S L_{3,2}-edge was shifted by 1.5 eV, which means partially oxidized Sⁿ⁻ (n<2). It can be seen that two additional peaks disappear in S 2p XPS after discharging and S L_{3,2}-edge returns to a pre-charge state, and thus it can be confirmed that a redox reaction of sulfur may be reversibly performed.

As can be understood from (b) of FIG. 23 and FIG. 26, a reversible redox reaction of phosphorus in the charging and discharging process may be confirmed. The pre-edge and the broad-edge were shifted about 0.41 eV and 0.32 eV, respectively after charging, and two additional peaks may be confirmed in P 2p XPS, which may confirm the presence of oxidized phosphorus (P²⁻ Pⁿ⁻, 2<n<3). In addition, two additional peaks disappeared in P 2p XPS after discharging and returned to a pre-charge state, and thus it can be confirmed that a reversible redox reaction may be performed.

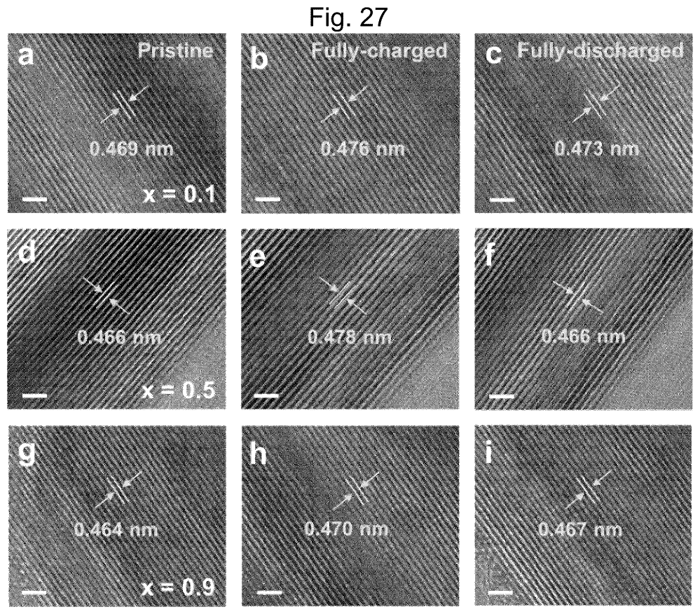

FIG. 27 is an HRTEM picture of an electrode structure according to Experimental Example 1 in a charged/discharged state of a secondary battery according to Experimental Example 1 of the present application.

Referring to FIG. 27, an HRTEM picture of an electrode structure according to Experimental Example 1 was taken in a charged/discharged state of a secondary battery according to Experimental Example 1. CuP_{0.1}S_{0.9}, CuP_{0.5}S_{0.5}, and CuP_{0.9}S_{0.1} were used for the electrode structure according to Experimental Example 1. a, b and c of FIG. 59 show an HRTEM picture of CuP_{0.1}S_{0.9}, d, e and f of FIG. 59 show an HRTEM picture of CuP_{0.5}S_{0.5}, and g, h and i of FIG. 59 show an HRTEM picture of CuP_{0.9}S_{0.1}.

As described above, in the case of CuP_{0.1}S_{0.9} and CuP_{0.9}S_{0.1}, a redox band of Cu may be positioned to be higher than an S 3p band, and thus the oxidized sulfur may be unstable. Accordingly, as shown in FIG. 27, it can be confirmed that the lattice spacing is not reversibly recovered even when charging and discharging are performed. In contrast, in the case of CuP_{0.5}S_{0.5}, it can be confirmed that the lattice spacing before charging is 0.466 nm, the lattice spacing after charging is 0.478 nm, and the lattice spacing after discharging is 0.466 nm, thus suggesting that the lattice spacing is reversibly recovered after charging and discharging.

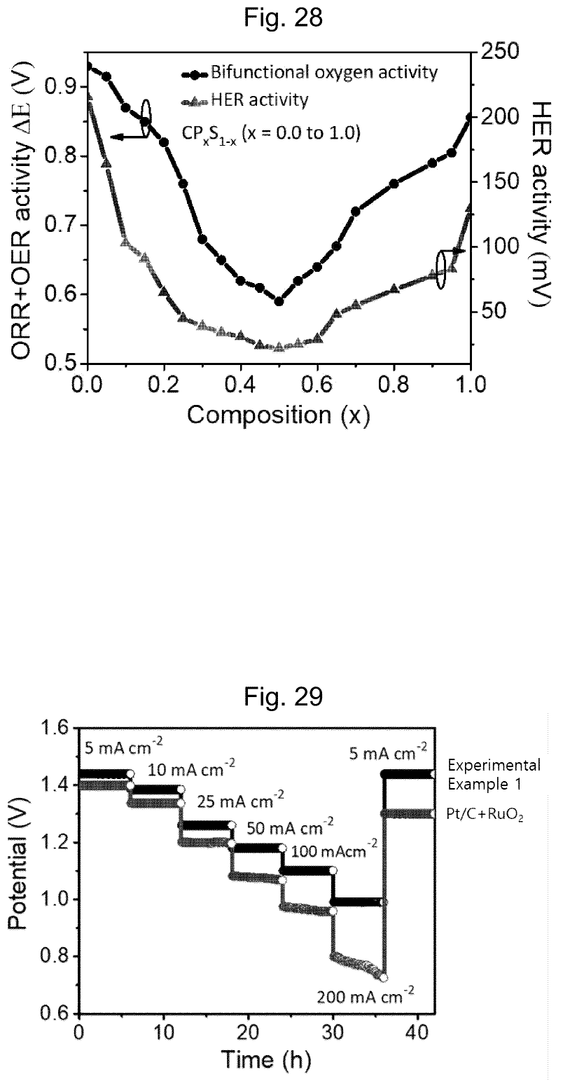

FIG. 28 is a graph showing an evaluation of ORR, OER, and HER properties according to a composition ratio of P and S in an electrode structure according to Experimental Example 1 of the present application.

Referring to FIG. 28, the ORR, OER, and HER properties according to a composition ratio of P and S were measured and shown with regard to the CuPS electrode structure according to Experimental Example 1.

As can be understood from FIG. 28, it can be confirmed for the CuPS electrode structure that ORR, OER and HER properties are excellent when a composition ratio of P is more than 0.3 and less than 0.7 and a composition ratio of S is less than 0.7 and more than 0.3. In other words, it can be confirmed for the CuPS electrode structure that controlling of the composition ratio of P to be more than 0.3 and less than 0.7 and the composition ratio of S to be less than 0.7 and more than 0.3 is an efficient method capable of improving ORR, OER and HER properties.

FIG. 29 is a graph showing a comparison of discharge voltage according to a current density of a zinc-air battery including an electrode structure according to Experimental Example 1 of the present application.

Referring to FIG. 29, a zinc-air battery according to Comparative Example was manufactured by using Pt/C and RuO₂ positive electrode, A201 (Tokuyama) electrolyte, and zinc negative electrode, and a discharge voltage according to 5-200 mAcm⁻² current density as well as a zinc-air battery including the electrode structure according to Experimental Example 1 was measured.

As can be understood from FIG. 29, it can be confirmed that the zinc-air battery including the CuPS electrode structure according to Experimental Example 1 has a remarkably high discharge voltage and, in particular, the zinc-air battery including Pt/C and RuO₂ positive electrode according to Comparative Example has a remarkably deteriorating discharge voltage as the current density increases. In contrast, it can be confirmed that the zinc-air battery including the CuPS electrode structure according to Experimental Example 1 does not have a significantly deteriorating discharge voltage compared to the zinc-air battery according to Comparative Example even under a high current density condition.

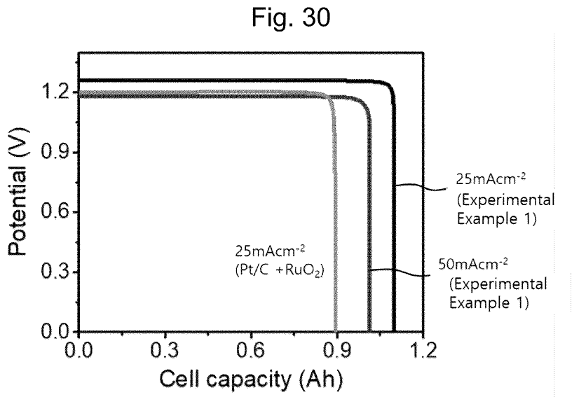

FIG. 30 is a graph for explaining a charge/discharge capacity of a zinc-air battery according to Experimental Example 1 of the present application.

Referring to FIG. 30, a capacity according to a current density of the zinc-air battery according to Comparative Example described above and the zinc-air battery according to Experimental Example 1 was measured.

As can be understood from FIG. 30, it can be confirmed that the zinc-air battery according to Experimental Example 1 including the CuPS electrode structure has a higher capacity value not only under the 25 mAcm⁻² condition, but also under the 50 mAcm⁻² condition, as well as compared with the 25 mAcm⁻² condition of the zinc-air battery according to Comparative Example using Pt/C and RuO₂ as a positive electrode.

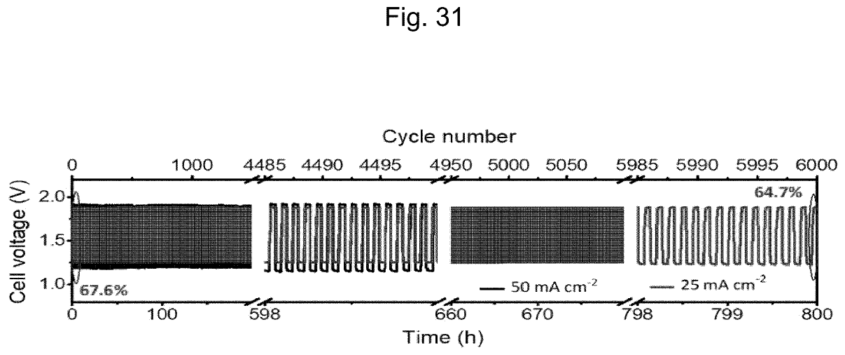

FIG. 31 is a graph showing a measurement of a voltage value according to the number of charges/discharges of a zinc-air battery according to Experimental Example 1 of the present application.

Referring to FIG. 31, a voltage value according to the number of times of charging and discharging was measured under the 50 mAcm⁻² condition and under the 25 mA⁻² conditions with regard to the zinc-air battery according to Experimental Example 1.

As can be understood from FIG. 31, it can be confirmed that stable driving is performed during about 600 times of charging and discharging. In other words, it can be confirmed that the CuPS electrode structure manufactured according to the above-described embodiment of the present application may be stably used as a positive electrode together with a solid electrolyte.

Manufacturing of Electrode Structure According to Experimental Example 2

An electrode structure according to Experimental Example 2 was manufactured by performing the method for manufacturing the electrode structure according to Experimental Example 1, but using ifosfamide as the second precursor having phosphorus.

Manufacturing of Electrode Structure According to Experimental Example 3

Dithiooxamide was prepared as a first precursor having sulfur, ifosfamide was prepared as a second precursor having phosphorus, copper chloride was prepared as a third precursor having copper, and a mixture of ethanol and ethylenediamine (1:3 v/v %) was prepared as a solvent.

The first to third precursors were added to the solvent and stirred to prepare a suspension.

2.5 M % ammonium hydroxide was added as a reducing agent, stirred for two hours without an additional heat-treatment process, after which an intermediate product was obtained, washed with deionized water and ethanol, and dried under vacuum at 50° C.

After that, the intermediate product was mixed and stirred in 20 ml of deionized water including Triton X-165 as a surfactant and a phosphorus acid source. After that, the resulting mixture was heat treated under pressure at 120° C. for 24 hours to manufacture an electrode structure including a compound of copper, phosphorus, and sulfur.

After that, the resulting product was washed with deionized water and ethanol to adjust to neutral pH, and freeze-dried in vacuum, so as to manufacture a CuPS electrode structure according to Experimental Example 3.

Manufacturing of Electrode Structure According to Experimental Example 4

Dithiooxamide, thioacetamide, ammonium sulfide, thiourea, and sodium thiophosphate were prepared as a first precursor having sulfur; phosphorus acid, ifosfamide, triphenylphosphine, tetradecylphosphonic acid, and sodium thiophosphate were prepared as a second precursor having phosphorus; Mn chloride, Fe chloride, Co chloride, Ni chloride, Ca chloride, Zn chloride, and Mg chloride were prepared as a third precursor having a transition metal; distilled water, ethanol, oleylamine, dimethylformamide, ethylenediamide, and pyrrolidone were prepared as a solvent; and Triton X-165, Triton X-100, HCl, hexamethylenetetramine, polyoxyethylene, and dodecanol were prepared as a surfactant.

The first to third precursors were added to the ethanol and stirred to prepare a suspension.

2.5 M % ammonium hydroxide was added as a reducing agent, stirred for two hours without an additional heat-treatment process, after which an intermediate product was obtained, washed with deionized water and ethanol, and dried under vacuum at 50° C.

After that, the intermediate product was mixed and stirred in 20 ml of the solvent including the surfactant and a phosphorus acid source. After that, the resulting mixture was heat treated under pressure at 120° C. for 24 hours to manufacture an electrode structure including a compound of copper, phosphorus and sulfur.

After that, the resulting product was washed with deionized water and ethanol to adjust to neutral pH, and freeze-dried in vacuum, so as to manufacture a CuPS electrode structure.

The first to third precursors, the solvent, and the surfactant were used as follows.

Specifically, in Experimental Examples 4-1-1 to 4-1-5, phosphorus acid, Cu chloride, ethanol, and Triton X-165 were used as the second precursor, the third precursor, the solvent, and the surfactant.

TABLE 1

| Classification | First precursor |
|---|---|
| Experimental Example 4-1-1 | Dithiooxamide |
| Experimental Example 4-1-2 | Thioacetamide |
| Experimental Example 4-1-3 | Ammonium sulfide |
| Experimental Example 4-1-4 | Thiourea |
| Experimental Example 4-1-5 | Sodium thiophosphate |

In Experimental Examples 4-2-1 to 4-2-5, dithiooxamide, Cu chloride, ethanol, and Triton X-165 were used as the first precursor, the third precursor, the solvent, and the surfactant.

TABLE 2

| Classification | Second precursor |
|---|---|
| Experimental Example 4-2-1 | Phosphorus acid |
| Experimental Example 4-2-2 | Ifosfamide |
| Experimental Example 4-2-3 | Triphenylphosphine |
| Experimental Example 4-2-4 | Tetradecylphosphonic acid |
| Experimental Example 4-2-5 | Sodium thiophosphate |

In Experimental Examples 4-3-1 to 4-3-6, dithiooxamide, phosphorus acid, Cu chloride, and ethanol were used as the first precursor, the second precursor, the third precursor, and the solvent.

TABLE 3

| Classification | Surfactant |
|---|---|
| Experimental Example 4-3-1 | Triton X-165 |
| Experimental Example 4-3-2 | Triton X-100 |
| Experimental Example 4-3-3 | HCl |
| Experimental Example 4-3-4 | Hexamethylenetetramine |
| Experimental Example 4-3-5 | Polyoxyethylene |
| Experimental Example 4-3-6 | Dodecanol |

In Experimental Examples 4-4-1 to 4-4-6, dithiooxamide, phosphorus acid, Cu chloride, and Triton X-165 were used as the first precursor, the second precursor, the third precursor, and the surfactant.

TABLE 4

| Classification | Solvent |
|---|---|
| Experimental Example 4-4-1 | Distilled water |
| Experimental Example 4-4-2 | Ethanol |
| Experimental Example 4-4-3 | Oleylamine |
| Experimental Example 4-4-4 | dimethylformamide |
| Experimental Example 4-4-5 | ethylenediamide |
| Experimental Example 4-4-6 | pyrrolidone |

In Experimental Examples 4-5-1 to 4-5-6, dithiooxamide, phosphorus acid, ethanol, and Triton X-165 were used as the first precursor, the second precursor, the solvent, and the surfactant.

TABLE 5

| Classification | Third precursor |
|---|---|
| Experimental Example 4-5-1 | Mn chloride |
| Experimental Example 4-5-2 | Fe chloride |
| Experimental Example 4-5-3 | Co chloride |
| Experimental Example 4-5-4 | Ni chloride |
| Experimental Example 4-5-5 | Ca chloride |
| Experimental Example 4-5-6 | Zn chloride |
| Experimental Example 4-5-7 | Mg chloride |
| Experimental Example 4-5-8 | Cu chloride |

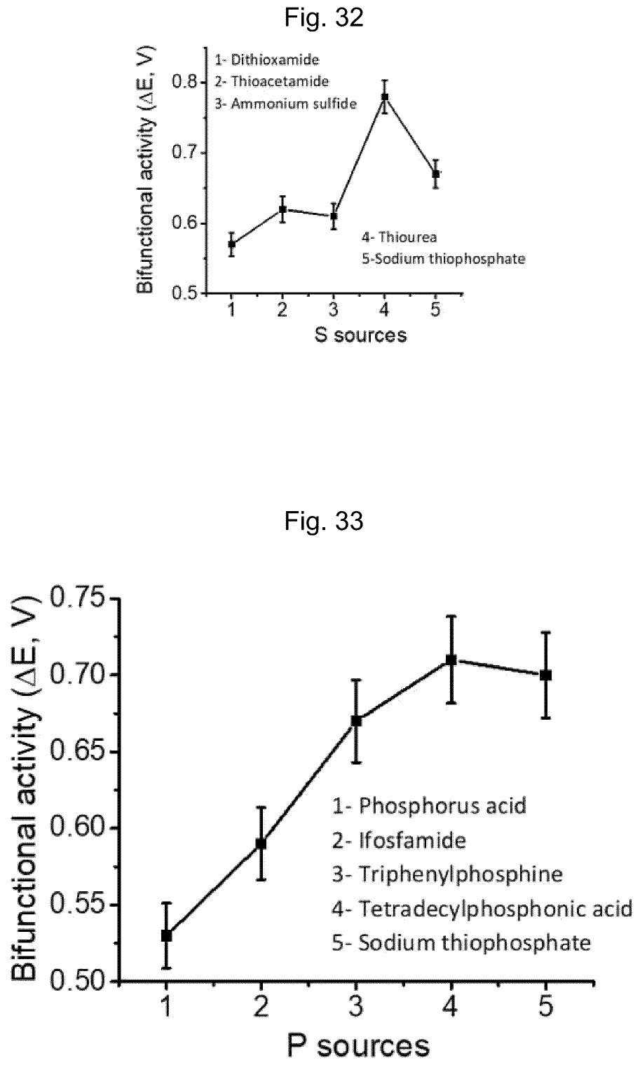

FIG. 32 is a graph showing a measurement of bifunctional activity of electrode structures according to Experimental Examples 4-1-1 and 4-1-5 of the present application.

Referring to FIG. 32, a bifunctional activity value of electrode structures according to Experimental Examples 4-1-1 and 4-1-5 of the present application was measured. A reversible bifunctional reaction of oxygen may be determined by a bifunctional activity value corresponding to a difference (ΔE) between the overpotentials of ORR and OER, and as the difference is smaller, the reversibility may be higher.

As shown in FIG. 32, a bifunctional activity value of electrode structures according to Experimental Examples 4-1-1 and 4-1-3 was measured to be relatively low, but a bifunctional activity value of electrode structures according to Experimental Examples 4-1-4 and 4-1-5 was measured to be relatively high. Specifically, it was confirmed that the activity for dithiooxamide, thioacetamide, and ammonium sulfide is excellent due to a covellite phase structure of the electrode structure, whereas thiourea and sodium thiophosphate are relatively less active due to a formation of a chalcocite structure. In conclusion, it can be confirmed that controlling the first precursor including sulfur to include any one of dithiooxamide, thioacetamide, or ammonium sulfide is an efficient method for improving the electrochemical properties of the electrode structure.

FIG. 33 is a graph showing a measurement of bifunctional activity of electrode structures according to Experimental Examples 4-2-1 and 4-2-5 of the present application.

Referring to FIG. 33, a bifunctional activity value of electrode structures according to Experimental Examples 4-2-1 and 4-2-5 of the present application was measured.

As shown in FIG. 33, a bifunctional activity value of electrode structures according to Experimental Examples 4-2-1 and 4-2-2 was measured to be relatively low, but a bifunctional activity value of electrode structures according to Experimental Examples 4-1-3 and 4-1-5 was measured to be relatively high. In conclusion, it can be confirmed that controlling the second precursor including phosphorus to include any one of phosphorus acid or ifosfamide is an efficient method for improving the electrochemical properties of the electrode structure.

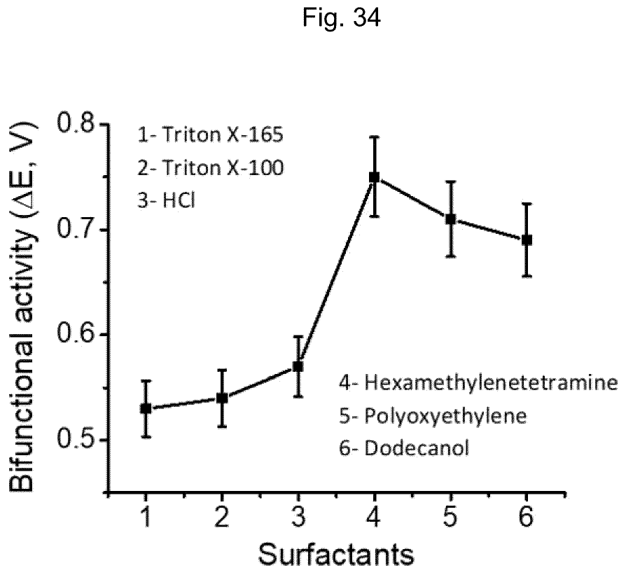

FIG. 34 is a graph showing a measurement of bifunctional activity of electrode structures according to Experimental Examples 4-3-1 and 4-3-6 of the present application.

Referring to FIG. 34, a bifunctional activity value of electrode structures according to Experimental Examples 4-3-1 and 4-3-6 of the present application was measured.

As shown in FIG. 34, a bifunctional activity value of electrode structures according to Experimental Examples 4-3-1 and 4-3-3 was measured to be relatively low, but a bifunctional activity value of electrode structures according to Experimental Examples 4-3-4 and 4-3-6 was measured to be relatively high. In conclusion, it can be confirmed that controlling the surfactant to include any one of Triton X-165, Triton X-100, or HCl is an efficient method for improving the electrochemical properties of the electrode structure.

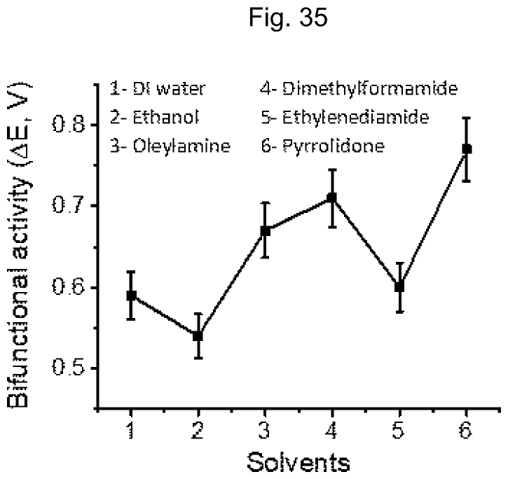

FIG. 35 is a graph showing a measurement of bifunctional activity of electrode structures according to Experimental Examples 4-4-1 and 4-4-6 of the present application.

Referring to FIG. 35, a bifunctional activity value of electrode structures according to Experimental Examples 4-4-1 and 4-4-6 of the present application was measured.

As shown in FIG. 35, a bifunctional activity value of electrode structures according to Experimental Examples 4-4-1 to 4-4-2 and 4-4-5 was measured to be relatively low, but a bifunctional activity value of electrode structures according to Experimental Examples 4-4-3 to 4-4-4 and 4-4-6 was measured to be relatively high. In conclusion, it can be confirmed that controlling the solvent to include any one of distilled water, alcohol including ethanol, or ethylenediamide is an efficient method for improving the electrochemical properties of the electrode structure.

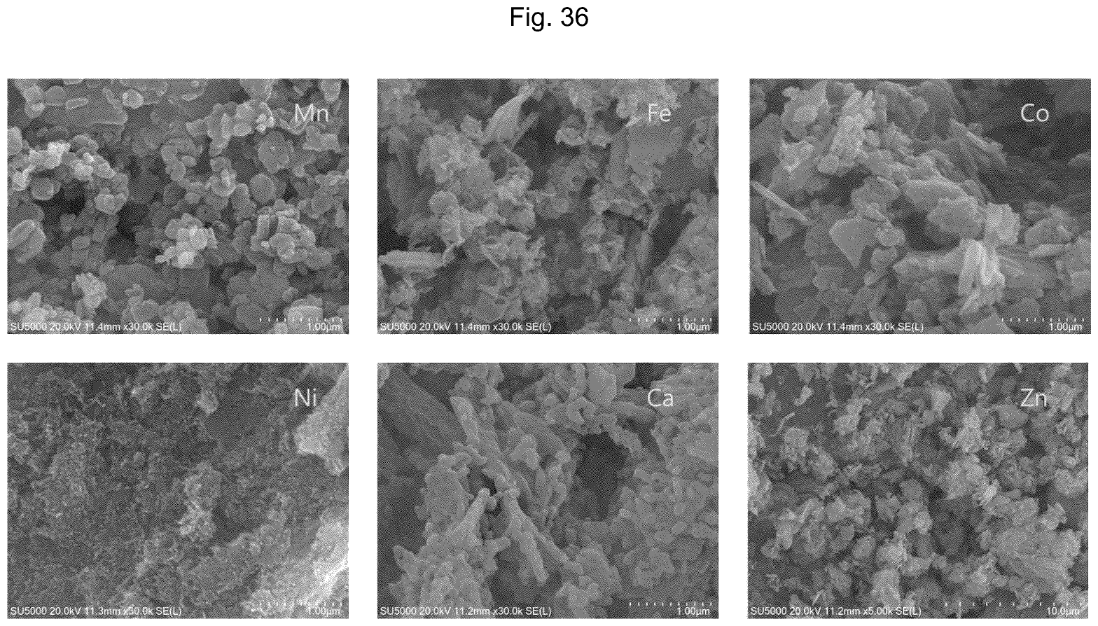

FIG. 36 is a view showing an SEM picture of an electrode structure according to Experimental Examples 4-5-1 to 4-5-6 of the present application.

Referring to FIG. 36, an SEM picture was taken of electrode structures according to Experimental Examples 4-5-1 to 4-5-6.

As can be understood from FIG. 36, it can be confirmed that the surface morphology and profile of an electrode structure are controlled according to a type of metal.

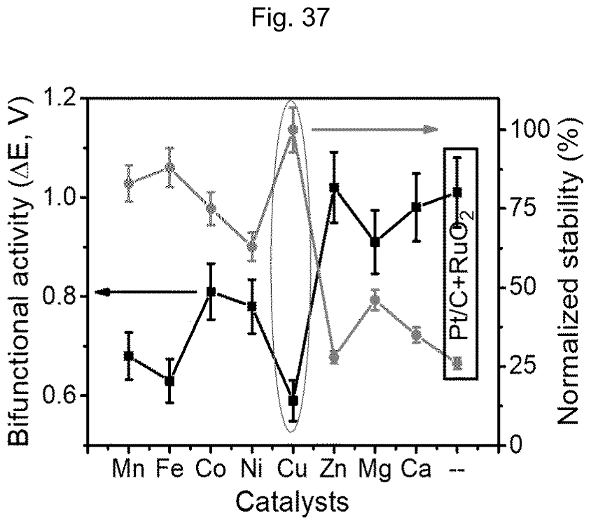

FIG. 37 is a graph showing a measurement of bifunctional activity of electrode structures according to Experimental Examples 4-5-1 and 4-5-8 of the present application.

Referring to FIG. 37, a bifunctional activity value of electrode structures according to Experimental Examples 4-5-1 and 4-5-8 of the present application was measured.

As shown in FIG. 37, a bifunctional activity value of electrode structures according to Experimental Examples 4-5-1 to 4-5-2 and 4-5-8 was measured to be relatively low, but a bifunctional activity value of electrode structures according to Experimental Examples 4-5-3 to 4-5-7 was measured to be relatively high, thereby showing low stability. In conclusion, it can be confirmed that controlling the transition metal to include one of Mn, Fe and Cu is an efficient method for improving the electrochemical properties of the electrode structure.

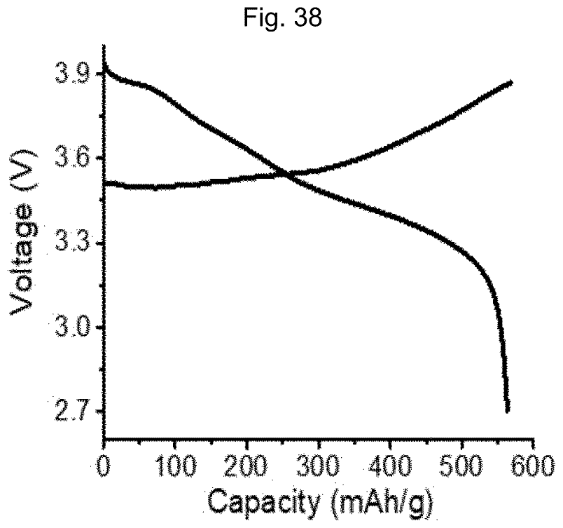

FIG. 38 is a graph showing a result of charging and discharging a lithium ion secondary battery including an electrode structure according to Experimental Example 4 of the present application.

Referring to FIG. 38, according to Experimental Example 4, an electrode structure manufactured using dithiooxamide, phosphorus acid, Cu chloride, ethanol, and Triton X-165 as a first precursor, a second precursor, a third precursor, a solvent, and a surfactant was used as a positive electrode, electrolyte including LiPF6 was used, and a lithium electrode was used as a negative electrode, so as to manufacture a lithium ion secondary battery and perform charging and discharging.

As can be understood from FIG. 38, it can be confirmed that capacity of about 560 mAh/g and voltage of 3.5 V value are provided. In other words, it can be seen that a positive electrode material of a lithium ion secondary battery capable of intercalating and deintercalating lithium ions may be prepared by using the electrode structure according to an embodiment of the present application formed of a compound of a transition metal, phosphorus, and a chalcogen element.

Although the present invention has been described in detail with reference to exemplary embodiments, the scope of the present invention is not limited to a specific embodiment and should be interpreted by the attached claims. In addition, those skilled in the art should understand that many modifications and variations are possible without departing from the scope of the present invention.

An electrode structure according to an exemplary embodiment of the present application may be utilized in various industrial fields such as a metal-air secondary battery, a lithium ion secondary battery, etc.

What is claimed is:

1. A method for manufacturing an electrode structure, the method comprising:
providing a first precursor having a chalcogen element, a second precursor having phosphorus, and a third precursor having a transition metal;
preparing a suspension by mixing the first precursor, the second precursor, and the third precursor in a first solvent;
adding a reducing agent to the suspension and causing a reaction therebetween to produce an intermediate product; and
adding the intermediate product and a surfactant to a second solvent and heat-treating under pressure, to manufacture an electrode structure including the chalcogen element, the phosphorus, and the transition metal.

2. The method of claim 1, wherein the preparing of the intermediate product comprises adding the reducing agent to the suspension, and then stirring the suspension at normal temperature.

3. The method of claim 1, wherein the first precursor comprises at least one of dithiooxamide, thiourea, ammonium sulfide, sodium sulfide, thioacetamide, or sodium thiophosphate;
the second precursor comprises at least one of phosphorus acid, ifosfamide, triphenylphosphine, tetradecylphosphonic acid, or sodium thiophosphate; and
the third precursor comprises at least one of a transition metal chloride, a transition metal sulfide, or a transition metal nitride.

4. The method of claim 1, wherein the surfactant comprises at least one of Triton X-165, Triton X-100, H₂SO₄, HCl, hexamethylenetetramine, hexadecyltrimethylammonium bromide, ammonium sulfate, polyoxyethylene, dodecanol, tridecane, or stearic acid.

5. The method of claim 1, wherein the first solvent and the second solvent comprise at least one of alcohol, DMF, oleic acid, oleylamine, 1-octadecene, trioctylphosphine, ethylenediamine, pyrrolidone, tributylamine, amine-based solvent, or deionized water.

6. The method of claim 1, wherein the transition metal comprises at least one of Cu, Mn, Fe, Co, Ni, Zn, Mg, or Ca.

7. The method of claim 1, wherein the electrode structure is in a form of a plurality of fibrillated fibers including a plurality of stems and a plurality of branches branched off from the plurality of stems.

8. The method of claim 7, wherein the intermediate product in a form of the plurality of stems is formed in a process of adding the reducing agent to the suspension and causing a reaction therebetween,
and the plurality of branches are formed in a process of adding the intermediate product and the surfactant to the second solvent and heat-treating under pressure.

9. The method of claim 1, wherein a bifunctional activity, which is a difference value between overpotentials of ORR and OER of the electrode structure, is controlled by at least one of a type of the first precursor, a type of the second precursor, a type of the transition metal of the third precursor, a type of the surfactant, a type of the first solvent, or a type of the second solvent.

10. A method for manufacturing an electrode structure, the method comprising:
providing a first precursor having sulfur, a second precursor having phosphorus, and a third precursor having a transition metal in a first solvent including alcohol, adding a reducing agent, stirring, and causing a reaction therebetween at normal temperature to prepare an intermediate product; and
adding the intermediate product and a surfactant to a second solvent including alcohol and heat-treating under pressure to manufacture an electrode structure for a positive electrode of a secondary battery including a compound of the transition metal, sulfur, and phosphorus.

11. The method of claim 10, wherein the electrode structure is a positive electrode of a metal-air secondary battery or a lithium ion secondary battery.

12. The method of claim 10, wherein the first precursor comprises at least one of dithiooxamide, thioacetamide, or ammonium sulfide;
the second precursor comprises at least one of phosphorus acid or ifosfamide;
the transition metal of the third precursor comprises at least one of Cu, Fe, or Mn; and
the surfactant comprises at least one of Triton X-165, Triton X-100, or HCl.

13. An electrode structure for a positive electrode of a secondary battery, wherein the electrode structure comprises a membrane in which a plurality of fibrillated fibers formed of a compound of a transition metal, phosphorus and sulfur form a network.

14. The method of claim 13, wherein the plurality of fibers formed of a compound of a transition metal, phosphorus and sulfur comprises a plurality of stems, and a plurality of branches branched off from the plurality of stems; and
the membrane of the electrode structure has a sponge structure and is flexible.

15. An electrode structure for a positive electrode of a lithium ion secondary battery for intercalating and deintercalating lithium ions during a charge/discharge process,
wherein the electrode structure comprises a compound of a transition metal, sulfur and phosphorus.

16. The electrode structure of claim 15, wherein the transition metal of the electrode structure comprises at least one of copper, magnesium, manganese, cobalt, iron, nickel, titanium, zinc, aluminum, or tin.

17. The electrode structure of claim 15, the electrode structure comprises a membrane in which a plurality of fibers which are fibrillated by a plurality of stems and a plurality of branches branched off from the plurality of stems form a network.

18. The electrode structure of claim 15, the transition metal of the electrode structure comprises copper, and
the electrode structure is represented by <Formula 1> below.
CuPₓS_{y} <Formula 1>
(wherein x+y=1, 0.3≤x≤0.7, 0.3≤y≤0.7)

19. The electrode structure of claim 15, the electrode structure has a sponge structure and is flexible.

20. A lithium ion secondary battery comprising:
a positive electrode including the electrode structure of claim 15;
a negative electrode on the positive electrode; and
an electrolyte between the positive electrode and the negative electrode.
